(19) United States
(12) Patent Application Publication
(10) Pub. No.: US 2008/0184797 A1
(43) Pub. Date: Aug. 7, 2008

(54) Hit command processing system, operation system for electronic instrument, and electronic instrument

(75) Inventor: Kazuo Kawaguchi, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 12/010,969

(22) Filed: Jan. 31, 2008

(30) Foreign Application Priority Data
Feb. 1, 2007 (JP) 2007-023314
Apr. 13, 2007 (JP) 2007-105558
Nov. 26, 2007 (JP) 2007-304533

(51) Int. Cl. G01P 9/00; G01H 11/00

(52) U.S. Cl. 73/504.02; 73/649

(57) ABSTRACT

A hit command processing system for an electronic instrument includes: an angular velocity sensor; an analog processing circuit which receives the analog signal output from the angular velocity sensor, converts the analog signal into a digital signal, and outputs the digital signal as a rotational angular velocity value; a hit input detection section which receives the rotational angular velocity value output from the analog processing circuit, and determines whether or not a hit input is performed to an electronic instrument based on a change in the rotational angular velocity value; and a hit command execution section which executes a command associated with the hit input when the hit input detection section has determined that the hit input has been performed.

Japanese Patent Application No. 2007-105558, filed on Apr. 13, 2007, Japanese Patent Application No. 2007-23314, filed on Feb. 1, 2007, and Japanese Patent Application No. 2007-304533, filed on Nov. 26, 2007, are hereby incorporated by reference in their entirety.

### BACKGROUND OF THE INVENTION

The present invention relates to a hit command processing system, an operation system for an electronic instrument, and an electronic instrument.

A gyrosensor measures a rotational velocity (rotational angular velocity) with respect to a rotational motion around a specific rotation axis. A vibrating gyrosensor which detects a rotational angular velocity utilizing a Coriolis force is widely used at present.

In a vibrating gyroscope which operates utilizing a piezoelectric effect, a Coriolis force occurs when applying an alternating-current voltage to a gyro-element (e.g., vibrator such as rock crystal), and a current is generated depending on the rotation rate or angular velocity. The gyrosensor amplifies a current signal and outputs a voltage proportional to the angular velocity.

In recent years, a micro-sized gyrosensor with reduced power consumption has been developed. Such a gyrosensor is packaged together with an analog front-end circuit and an A/D conversion circuit, is incorporated in a portable telephone, a digital camera, or the like, and is utilized for shake correction or the like.

A command used to operate an electronic instrument is input by operating a button provided on the electronic instrument, a remote controller, or the like. This poses a problem such as poor operability, an increase in operation time, or incapability of operation when a remote controller is lost.

In the case of a display device such as a flat-screen television, when provide an operation section (e.g., button) on the main body of the display device, the width of the housing is limited due to wiring.

### SUMMARY

According to a first aspect of the invention, there is provided a hit command processing system for an electronic instrument, the hit command processing system comprising:

an angular velocity sensor which detects a rotational angular velocity and outputs an analog signal corresponding to the rotational angular velocity;

an analog processing circuit which receives the analog signal output from the angular velocity sensor, converts the analog signal into a digital signal, and outputs the digital signal as a rotational angular velocity value;

a hit input detection section which receives the rotational angular velocity value output from the analog processing circuit, and determines whether or not a hit input is performed to an electronic instrument based on a change in the rotational angular velocity value; and

a hit command execution section which executes a command associated with the hit input when the hit input detection section has determined that the hit input has been performed.

According to a second aspect of the invention, there is provided a hit command processing system for an electronic instrument, the hit command processing system comprising:

a hit input detection section which determines whether or not a hit input is performed based on a change in a rotational angular velocity value; and

a hit command execution section which executes a command associated with the hit input when the hit input detection section has determined that the hit input has been performed.

According to a third aspect of the invention, there is provided an operation system for an electronic instrument, the operation system comprising:

a vibration detection sensor which detects vibrations of the electronic instrument;

a hit input detection section which determines whether or not a hit input is performed to the electronic instrument based on an output signal from the vibration detection sensor; and

an operation signal generation section which generates an operation signal which operates the electronic instrument depending on whether or not the hit input is performed.

According to a fourth aspect of the invention, there is provided an electronic instrument operating based on an operation signal, the electronic instrument comprising:

a vibration detection sensor which detects vibrations of the electronic instrument;

a hit input detection section which determines whether or not a hit input is performed to the electronic instrument based on an output signal from the vibration detection sensor; and

an operation signal generation section which generates an operation signal which operates the electronic instrument depending on whether or not the hit input is performed.

### BRIEF DESCRIPTION OF THE SEVERAL VIEWS OF THE DRAWING

FIG. 1 is a diagram illustrative of a configuration of a hit command processing system according to one embodiment of the invention.

FIG. 2 shows an example of an electronic instrument according to one embodiment of the invention.

FIGS. 3A and 3B are diagrams illustrative of a rotational angular velocity according to one embodiment of the invention.

FIG. 4 is a diagram illustrative of hit count determination according to one embodiment of the invention.

FIGS. 5A and 5B are diagrams illustrative of the relationship between a rotational angular velocity value detected within a hit command registration period and hit command determination registration information to be set.

FIG. 6 is a table for describing the correspondence relationship between a hit count and a command.

FIG. 7 is a table for describing changing a command to be associated corresponding to a processing system.

FIGS. 8A and 8B are diagrams illustrative of a hit area according to one embodiment of the invention.

FIG. 9 is a flowchart illustrative of the flow of a process which determines a hit count of an electronic instrument using a rotational angular velocity.

FIG. 10 is a flowchart illustrative of the flow of a process which registers the correspondence relationship between a hit count and a command.

FIG. 11 is a flowchart illustrative of the flow of a hit command determination information registration process.

FIG. 12 is a flowchart illustrative of the flow of a process which determines a hit count of an electronic instrument using hit command determination information.

FIG. 13 is a flowchart illustrative of the flow of a hit command detection learning function.

FIG. 14 is a block diagram illustrative of a configuration of an electronic instrument.

FIG. 15 is a diagram illustrative of a configuration of a hit command processing system according to a second embodiment of the invention.

FIG. 16 is a diagram showing the positional relationship between a plurality of switch areas and a gyrosensor provided in an electronic instrument.

FIGS. 17A and 17B are diagrams showing examples of an analog signal output from a gyrosensor when hitting each switch area.

FIG. 18 is a diagram showing the positional relationship between a plurality of switch areas and a gyrosensor provided in an electronic instrument.

FIGS. 19A to 19C are diagrams showing examples of an analog signal output from a gyrosensor when hitting each switch area.

FIG. 20 is a diagram showing the positional relationship between a plurality of switch areas and a plurality of gyrosensors provided on a flat surface of an electronic instrument.

FIGS. 21A to 21D are diagrams showing examples of analog signals output from a plurality of gyrosensors when hitting each switch area.

FIG. 22 is a diagram showing the positional relationship between four switch areas and two gyrosensors provided on a flat surface of an electronic instrument.

FIGS. 23A to 23D are diagrams showing examples of analog signals output from a plurality of gyrosensors when hitting each switch area.

FIG. 24 is a flowchart illustrative of the flow of a process which determines the presence or absence of a hit input using an electronic instrument utilizing a rotational angular velocity.

FIG. 25 is a diagram illustrative of an example of operating a flat-screen television using a hit input.

### DETAILED DESCRIPTION OF THE EMBODIMENT

The invention may provide a hit command processing system, an electronic instrument operation system, and an electronic instrument which enables an electronic instrument to be operated by hitting the electronic instrument.

(1) According to one embodiment of the invention, there is provided a hit command processing system for an electronic instrument, the hit command processing system comprising:

an angular velocity sensor which detects a rotational angular velocity and outputs an analog signal corresponding to the rotational angular velocity;

an analog processing circuit which receives the analog signal output from the angular velocity sensor, converts the analog signal into a digital signal, and outputs the digital signal as a rotational angular velocity value;

a hit input detection section which receives the rotational angular velocity value output from the analog processing circuit, and determines whether or not a hit input is performed to an electronic instrument based on a change in the rotational angular velocity value; and

a hit command execution section which executes a command associated with the hit input when the hit input detection section has determined that the hit input has been performed.

The term “electronic instrument” used herein may be a portable telephone, a portable game machine, a portable player, or a portable personal computer, or a stationary electronic instrument such as a television, an audio system, a projector, an air-conditioner, a lighting device, or a household appliance, or a controller separately provided from an electronic instrument main body and used to operate the main body.

The angular rate sensor measures a rotational velocity (rotational angular velocity) with respect to a rotational motion around a specific rotation axis, and outputs an analog signal corresponding to the rotational angular velocity. The angular rate sensor may be a gyrosensor. The type of gyrosensor is arbitrary.

The rotational angular velocity with respect to a given axis may be received, or the rotational angular velocity with respect to each of three axes which intersect perpendicularly may be received.

The analog processing circuit is an analog front-end circuit, for example. The analog processing circuit may include a low-pass filter, an operational amplifier, an A/D converter, and the like.

The hit input detection section and the hit command execution section may be implemented by causing a CPU or a microcomputer including a CPU to execute a predetermined program, or may be implemented by a dedicated circuit, for example.

According to this embodiment, a command associated with a hit operation, a hit position, or a hit count can be executed by hitting the electronic instrument. Therefore, a command can be executed by hitting the electronic instrument without operating an operation section such as a button or a key, whereby an electronic instrument with excellent operability can be provided.

Moreover, an operation section such as a button or a key can be omitted.

(2) In this hit command processing system,

the hit input detection section may include a hit count detection section receiving the rotational angular velocity value output from the analog processing circuit and determining a hit count of the electronic instrument based on a change in the rotational angular velocity value; and

the hit command execution section may include a correspondence relationship storage section storing a correspondence relationship between the hit count and the command, and execute the command associated with the determined hit count based on the correspondence relationship.

The correspondence relationship storage section may be formed using a rewritable memory such as a flash memory or an EEPROM so that reference data can be set in the rewritable memory based on an external input. The correspondence relationship may be incorporated in an instruction code of a program, and a CPU may execute the program to function as the correspondence relationship storage section.

According to this embodiment, a command associated with the hit count can be executed by hitting the electronic instrument a given number of times.

(3) According to one embodiment of the invention, there is provided a hit command processing system for an electronic instrument, the hit command processing system comprising:

a hit input detection section which determines whether or not a hit input is performed based on a change in a rotational angular velocity value; and

a hit command execution section which executes a command associated with the hit input when the hit input detection section has determined that the hit input has been performed.

(4) In this hit command processing system,

the hit input detection section may include a hit count detection section determining a hit count of the electronic instrument based on a change in the rotational angular velocity value; and

the hit command execution section may include a correspondence relationship storage section storing a correspondence relationship between the hit count and the command, and execute the command associated with the determined hit count based on the correspondence relationship.

(5) In this hit command processing system,

the hit input detection section may determine whether or not the hit input is performed to a plurality of switch areas respectively set at different positions of the electronic instrument based on a change in a rotational angular velocity value of one angular velocity sensor; and

when the hit input detection section has determined that the hit input has been performed to a switch area among the switch areas, the hit command execution section may execute the command associated with the switch area.

The hit input detection section may determine the switch area which has been hit based on a change in the rotational angular velocity value of one angular velocity sensor.

The rotation direction and the degree of rotation of the gyrosensor differ when hitting each switch area having a different positional relationship with the angular velocity sensor. Therefore, the characteristics (e.g., amplitude direction and amplitude) of the output signal of the gyrosensor also differ. Therefore, it is possible to determine the hit switch area based on the characteristics of the output signal from the gyrosensor.

Therefore, if different commands are respectively associated with the switch areas, a plurality of commands can be input using one angular velocity sensor.

(6) In this hit command processing system,

the hit input detection section may determine whether or not the hit input is performed to a plurality of switch areas respectively set at different positions of the electronic instrument based on a change in rotational angular velocity values of a plurality of the angular velocity sensors respectively disposed at different positions of the electronic instrument; and

when the hit input detection section has determined that the hit input has been performed to a switch area among the switch areas, the hit command execution section may execute the command associated with the switch area.

The hit input detection section may determine the hit switch area based on a change in the rotational angular velocity value of a plurality of angular velocity sensors.

(7) The hit command processing system may further comprise:

a correspondence relationship setting section which sets the correspondence relationship between the hit count and the command based on an external input, and causes the correspondence relationship storage section to store the correspondence relationship.

According to this embodiment, the user can set or change the correspondence relationship between the hit count and the command according to the user's preference. Therefore, each user can set a convenient operation system. Moreover, since the setting differs depending on the user, security is enhanced because another person cannot operate the instrument.

(8) The hit command processing system may set a hit command registration period and further comprise a hit command determination information registration section which generates hit command determination information based on the rotational angular velocity value received within the hit command registration period, and causes a hit command determination information storage section to store the generated hit command determination information,

wherein the hit count detection section may determine the hit count of the electronic instrument based on the hit command determination information and a change in the rotational angular velocity value.

A range (extreme value range) for the extreme value (maximum value or minimum value) of a pulse used to determine occurrence of a hit operation may be set based on the rotational angular velocity value received within the hit command registration period as the hit command determination information, and whether or not the extreme value of the detected pulse is within the extreme value range may be determined. It may be determined that a hit operation has been performed when the extreme value of the detected pulse is within the extreme value range.

A threshold value used to determine the condition for the extreme value (maximum value and minimum value) of a pulse used to determine occurrence of a hit operation may be set based on the rotational angular velocity value received within the hit command registration period as the hit command determination information, and whether or not the extreme value of the detected pulse has exceeded the threshold value may be determined. It may be determined that a hit operation has been performed when the extreme value of the detected pulse has exceeded the threshold value.

The characteristics of a cycle (T) used to determine the interval of hit operations may be determined based on the rotational angular velocity value received within the hit command registration period as the hit command determination information, and a pulse may be detected using the cycle properties.

In general, the strength and the speed of the hit operation differ depending on the user even if the hit count is the same. According to this embodiment, the user performs a operation in the hit command registration period. The properties (e.g., strength or degree) of the hit operation of each user are detected based on a change in rotational angular velocity value which has occurred due to the hit operation, and are registered as the hit command determination registration information.

Therefore, when a hit operation differing from the properties (e.g., strength or degree) of the user, the commend is not executed. Accordingly, since the operation of another person is not accepted, an electronic instrument with high security performance can be provided.

(9) In this hit command processing system,

the hit count detection section may detect a pulse which satisfies an operation event generation condition based on a change in the rotational angular velocity value, and determine the hit count of the electronic instrument based on the pulse.

A range (extreme value range) for the extreme value (maximum value or minimum value) of a pulse used to determine occurrence of a hit operation may be set as the operation event generation condition, and whether or not the extreme value of the detected pulse is within the extreme value range may be determined. It may be determined that a hit operation has been performed when the extreme value of the detected pulse is within the extreme value range.

A threshold value used to determine the condition for the extreme value (maximum value and minimum value) of a pulse used to determine occurrence of a hit operation may be set as the operation event generation condition, and whether or not the extreme value of the detected pulse has exceeded the threshold value may be determined. It may be determined that a hit operation has been performed when the extreme value of the detected pulse has exceeded the threshold value.

The properties of a cycle used to determine the interval of hit operations may be determined based on the rotational angular velocity value received within the hit command registration period as the operation event generation condition, and a pulse may be detected using the cycle properties. This enables control so that the command is not executed when a hit operation has been performed in a cycle differing from a cycle during registration.

(10) In this hit command processing system,

the correspondence relationship storage section may store the correspondence relationship between the hit count and the command in processing system units; and

the hit command execution section may include processing system switch means for switching between a plurality of processing systems, and execute the command associated with the hit count determined for a present processing system based on the correspondence relationship.

According to this embodiment, various commands can be executed by a simple hit operation.

(11) In this hit command processing system, the hit command execution section may include means enabling or disabling the command, and execute the command associated with the determined hit count when the command is enabled.

(12) In this hit command processing system,

the hit command determination information registration section may include a historical information registration section generating the hit command determination information based on a change in the rotational angular velocity value when the command has been executed and causing the hit command determination information storage section to store the hit command identification information as command historical information; and

the hit count detection section may include a history reflection processing section which determines the hit count taking the command historical information into account.

The hit command determination information storage section may store z input values when a hit command has been previously executed as the command historical information. An allowable range (allowable range for an extreme value range, threshold value, cycle, and the like) may be determined based on the z pieces of command historical information, and the hit count may be determined based on the allowable range.

When the input value is within the allowable range and the hit count has been determined, a command associated with the hit count may be executed. The hit command determination information may be generated based on the rotational angular velocity value for the preceding x seconds, and stored in the in the hit command determination information storage section as the command historical information. The oldest command historical information may be deleted from the hit command determination information storage section. This enables the command historical information to be updated and maintained in the latest state.

According to this embodiment, a learning effect can be achieved in which the recent input tendency of the user can be reflected in hit count determination.

(13) The hit command processing system may further comprise a hit area to which the command is input outside the electronic instrument,

wherein the hit count detection section may set a determination condition for determining the hit count assuming that the hit area is hit, and determines the hit count.

The detection sensitivity of the angular velocity sensor can be increased by limiting the hit area.

(14) The hit command processing system may further comprise a contact detection section which detects contact with the hit area,

wherein the hit count detection section may determine the hit count based on a change in the rotational angular velocity value acquired in a period in which contact with the hit area is being detected.

The contact detection section may be implemented by a thermosensor, a touch panel, a switch, or the like.

A situation can be prevented in which a command is executed even if a hit operation is not performed for the hit area by providing the contact detection section which detects contact in the hit area. This prevents a situation in which a command is executed against the user's will.

A configuration may be employed in which a hit waveform within a predetermined period of time may be detected and accepted, even if contact with the hit area has not been detected, and a predetermined command is then executed.

(15) The hit command processing system may further comprise:

a grip section which is provided outside the electronic instrument and can be held by a user; and

a contact detection section which detects contact with the grip section,

wherein the hit count detection section may determine the hit count based on a change in the rotational angular velocity value acquired in a period in which contact with the grip section is being detected.

The contact detection section may be implemented by a thermosensor, a touch panel, a switch, or the like.

A command can be executed when the user performs a hit operation while holding the grip section by providing the contact detection section which detects contact in the grip section. This prevents a situation in which a command is executed against the user's will.

A configuration may be employed in which a hit waveform within a predetermined period of time may be detected and accepted, even if contact with the grip section has not been detected, and a predetermined command is then executed.

(16) According to one embodiment of the invention, there is provided an operation system for an electronic instrument, the operation system comprising:

a vibration detection sensor which detects vibrations of the electronic instrument;

a hit input detection section which determines whether or not a hit input is performed to the electronic instrument based on an output signal from the vibration detection sensor; and

an operation signal generation section which generates an operation signal which operates the electronic instrument depending on whether or not the hit input is performed.

According to this embodiment, the operation signal which operates the electronic instrument is generated when the user has hit the electronic instrument (e.g., based on the hit position or hit count). Specifically, this embodiment allows provision of an electronic instrument with excellent operability which can be operated by hitting the electronic instrument.

In this embodiment, the operation system may include a determination section which determines whether or not the output signal from the vibration detection sensor satisfies a predetermined condition (determination condition). In this case, an electronic instrument which operates only when a specific user performs a specific operation can be provided by appropriately setting the determination condition of the determination section. For example, the determination condition may be set so that the electronic instrument operates only when the user has hit a specific area of the electronic instrument with a specific strength or has hit the electronic instrument with a specific strength a specific number of times. This makes it possible to prevent malfunction of the electronic instrument or the electronic instrument from being used by another person.

The operation system may be generate an operation signal corresponding to the hit position or the hit count of the electronic instrument. This makes it possible to cause the electronic instrument to perform various operations by a simple operation of hitting the electronic instrument.

(17) According to one embodiment of the invention, there is provided an electronic instrument operating based on an operation signal, the electronic instrument comprising:

a vibration detection sensor which detects vibrations of the electronic instrument;

a hit input detection section which determines whether or not a hit input is performed to the electronic instrument based on an output signal from the vibration detection sensor; and

an operation signal generation section which generates an operation signal which operates the electronic instrument depending on whether or not the hit input is performed.

According to this embodiment, the operation signal which operates the electronic instrument is generated when the user has hit the electronic instrument (e.g., based on the hit position or hit count). Specifically, this embodiment allows provision of an electronic instrument with excellent operability which can be operated by hitting the electronic instrument.

In this embodiment, the electronic instrument may include a determination section which determines whether or not the output signal from the vibration detection sensor satisfies a predetermined condition (determination condition). In this case, an electronic instrument which operates only when a specific user performs a specific operation can be provided by appropriately setting the determination condition of the determination section. For example, the determination condition may be set so that the electronic instrument operates only when the user has hit a specific area of the electronic instrument with a specific strength or has hit the electronic instrument with a specific strength a specific number of times. This makes it possible to prevent malfunction of the electronic instrument or the electronic instrument from being used by another person.

The operation system may be generate an operation signal corresponding to the hit position or the hit count of the electronic instrument. This makes it possible to cause the electronic instrument to perform various operations by a simple operation of hitting the electronic instrument.

(18) The electronic instrument may further comprise a housing having no mechanism causing a user to perceive a hit vibration input area.

According to this embodiment, since another person cannot identify the hit area, it is difficult for the other person to reproduce hit vibrations. Therefore, an electronic instrument which can prevent illegal use by another person can be provided.

According to this embodiment, the electronic instrument may include a determination condition storage section which stores a determination condition used to determine hit vibrations, and a determination condition setting section which inputs the determination condition to the determination condition storage section. The determination condition setting section may set the determination condition based on the hit vibrations input within a determination condition registration period. According to this configuration, since it is difficult for a person other than the user which has input the determination condition to reproduce vibrations which satisfy the determination condition, the security performance of the electronic instrument can be implemented. In particular, an article differs in vibration pattern to be generated depending on the hit position. Therefore, when a mechanism by which the user can identify the hit vibration input area is not provided in the housing of the electronic instrument, it becomes further difficult for a person other than the user to reproduce vibrations which satisfy the determination condition. Moreover, since the hit vibrations by the user can be accurately detected, an electronic instrument with excellent operability can be provided.

The embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

### 1. First Embodiment

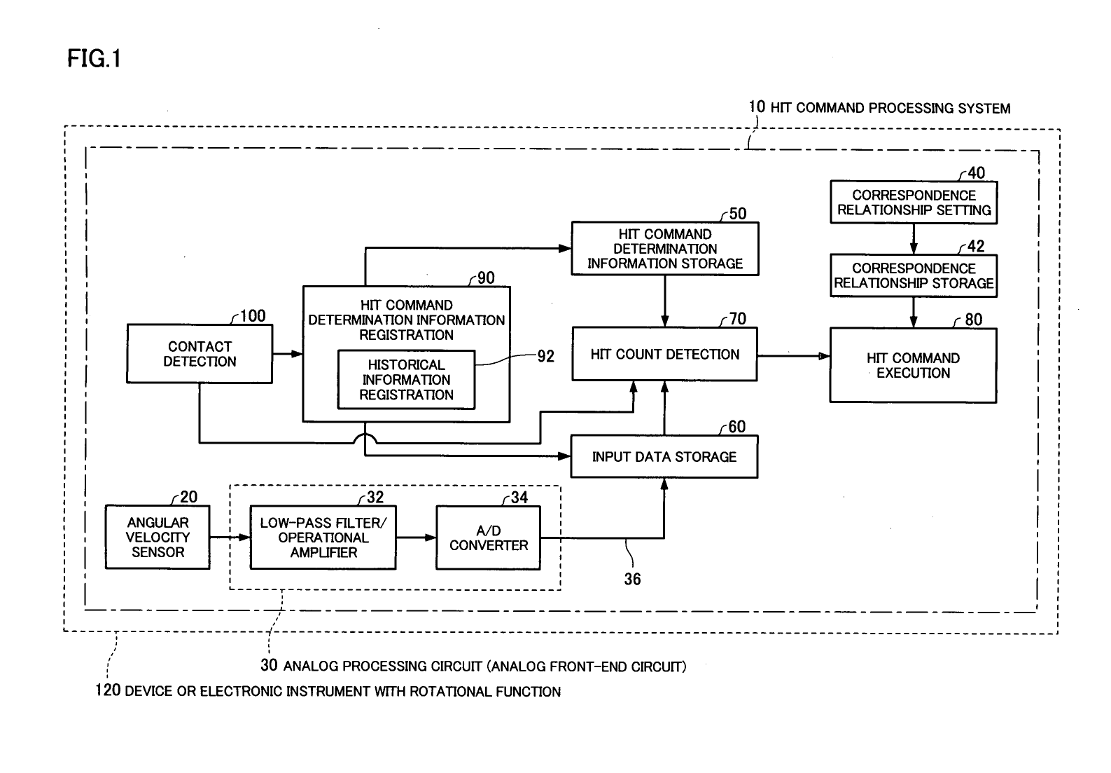

FIG. 1 is a diagram illustrative of a configuration of a hit command processing system according to one embodiment of the invention.

A hit command processing system 10 according to this embodiment includes an angular velocity sensor (gyrosensor) 20 as a vibration detection sensor. The angular rate sensor 20 measures a rotational velocity (rotational angular velocity) with respect to a rotation motion around a specific rotation axis, and outputs an analog signal 22 corresponding to the rotational angular velocity. The angular velocity sensor 20 may be a gyrosensor, for example. The gyrosensor may be a vibrating gyroscope which operates utilizing a piezoelectric effect, for example. In this type of gyrosensor, an alternating-current voltage is applied to an gyro-element (vibrator such as rock crystal) to cause the gyro-element to at least partially vibrate, and a current (voltage) corresponding to the rotation rate or the angular velocity is generated utilizing a Coriolis force. The gyrosensor amplifies a current signal and outputs a voltage proportional to the angular velocity. The type of gyrosensor is arbitrary. For example, a gyrosensor utilizing a microelectromechanical system (MEMS) technology may be used.

The rotational angular velocity with respect to a given axis may be detected, or may be detected with respect to three axes which intersect perpendicularly.

Note that the vibration detection sensor which may be applied to this embodiment is not limited to the angular velocity sensor. For example, the hit command processing system 10 according to this embodiment may include an acceleration sensor instead of, or in addition to, the angular rate sensor 20. Since the vibrations of an electronic instrument can also be detected using the acceleration sensor which detects the acceleration of an article, the presence or absence of a hit operation can be detected.

The hit command processing system 10 according to this embodiment includes an analog processing circuit (analog front-end circuit) 30. The analog processing circuit 30 includes a low-pass filter/operational amplifier 32 and an A/D converter 34. The analog processing circuit 30 receives the analog signal 22, and outputs a corresponding digital signal 36.

The hit command processing system 10 according to this embodiment includes an input data storage section 60. The input data storage section 60 holds the input digital signal (rotational angular velocity).

The hit command processing system 10 according to this embodiment includes a hit count detection section 70. The hit count detection section 70 receives a rotational angular velocity value 36 output from the analog processing circuit 30, and determines the hit count based on a change in rotational angular velocity value. For example, the hit count detection section 70 may be implemented by a CPU or a microcomputer including a CPU.

The hit count detection section 70 may detect a pulse which satisfies an operation event generation condition based on a change in rotational angular velocity value, and determine the hit count of an electronic instrument based on the detected pulse.

The hit command processing system 10 according to this embodiment includes a correspondence relationship storage section 42. The correspondence relationship storage section 42 stores the correspondence relationship between the hit count and a command. The correspondence relationship storage section 42 may be formed using a rewritable memory such as a flash memory or an EEPROM so that reference data can be set in the rewritable memory based on an external input. The correspondence relationship may be incorporated in an instruction code of a program, and a CPU may execute the program to function as the correspondence relationship storage section 42.

The hit command processing system 10 according to this embodiment includes a hit command execution section 80. The hit command execution section 80 executes a command associated with the determined hit count based on the correspondence relationship. For example, the hit command execution section 80 may be implemented by a CPU or a microcomputer including a CPU.

The hit command execution section 80 may include a means which enables or disables a hit command, and may execute a command associated with the determined hit count when the hit command is enabled.

The hit command processing system 10 according to this embodiment includes a correspondence relationship setting section 40. The correspondence relationship setting section 40 sets the correspondence relationship between the hit count and the command based on an external input, and stores the correspondence relationship in the correspondence relationship storage section. For example, the correspondence relationship setting section 40 may be implemented by a CPU or a microcomputer including a CPU.

The correspondence relationship storage section 40 may store the correspondence relationship between the hit count and the command in processing system units. The hit command execution section 80 may include a means which executes the command while switching between a plurality of processing systems, and execute a command associated with the hit count determined for the present processing system.

The hit command processing system 10 according to this embodiment includes a hit command determination information registration section 90. The hit command determination information registration section 90 generates hit command determination information based on a rotational angular velocity value received within a hit command registration period, and stores the hit command determination information in a hit command determination information storage section. For example, the hit command determination information registration section 90 may be implemented by a CPU or a microcomputer including a CPU.

The hit count detection section 70 may determine the hit count of an electronic instrument based on the hit command determination information and a change in rotational angular velocity value.

The hit command registration section 90 may include a historical information registration section 92. The historical information registration section 92 generates hit command identification information based on a change in rotational angular velocity value when the hit command is executed, and stores the hit command identification information in the hit command determination information storage section as hit command historical information. The hit count detection section 70 may determine the hit count taking the hit command historical information into account.

The hit count detection section 70 may set a determination condition used to determine the hit count provided that the user hits a hit area which is set in part of the electronic instrument for inputting the hit command, and determine the hit count.

The hit command processing system 10 according to this embodiment includes a contact detection section 100. The contact detection section 100 may detect contact with the hit area, and the hit count detection section 70 may determine the hit count based on a change in rotational angular velocity value acquired in a period in which the contact detection section 100 detects contact with the hit area.

The contact detection section 100 may detect contact with a grip section, and the hit count detection section 70 may determine the hit count based on a change in rotational angular velocity value acquired in a period in which the contact detection section 100 detects contact with the grip section.

The hit command processing system 10 according to this embodiment includes the contact detection section 100. The contact detection section 100 may determine the hit count based on a change in rotational angular velocity value acquired in a period in which the contact detection section 100 detects contact with the grip section.

The hit command processing system 10 according to this embodiment includes a hit command determination information storage section 50. The hit command determination information storage section 50 stores hit command determination information used to determine a given hit count generated based on a change in rotational angular velocity value when the corresponding hit command is executed.

For example, the hit command determination information may be a cycle of a change in rotational angular velocity value, an extreme value range, a threshold value of an extreme value, or the like.

The hit command determination information storage section 50 may be formed using a rewritable memory such as a flash memory or an EEPROM so that reference data can be set in the rewritable memory based on an external input.

The analog processing circuit 30 may be mounted on a semiconductor integrated circuit device (IC) which implements the hit command processing system 10 according to this embodiment, or may be mounted on another semiconductor integrated circuit device (IC).

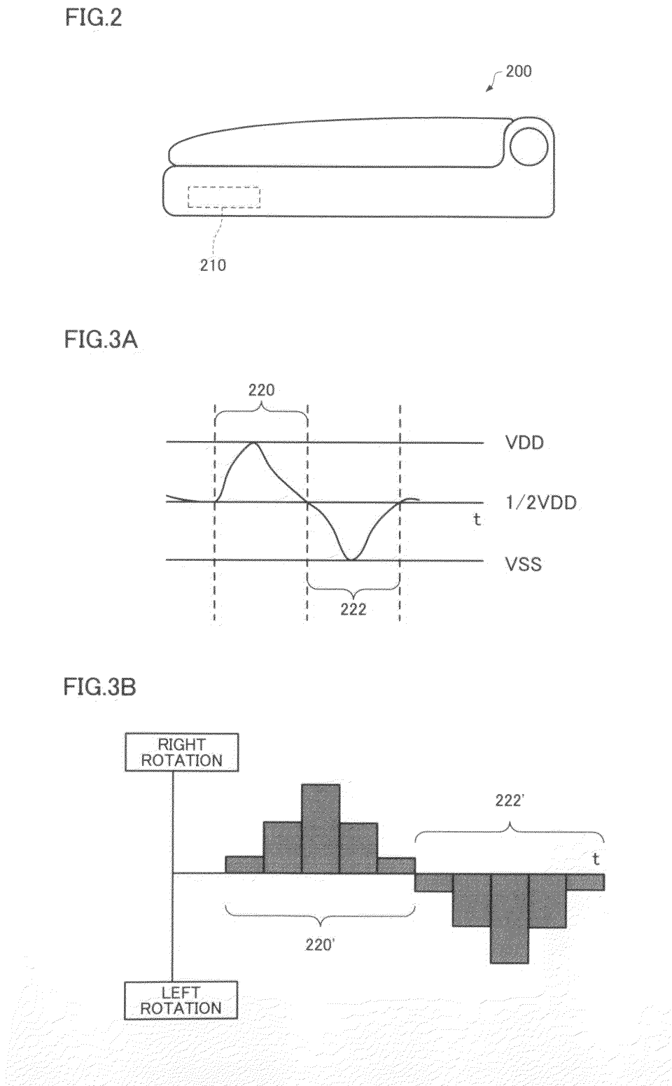

FIG. 2 shows a portable telephone which is an example of the electronic instrument according to this embodiment. As shown in FIG. 2, a portable telephone 200 according to this embodiment includes an angular velocity sensor (e.g., gyrosensor) 210 as a vibration detection sensor. The angular velocity sensor provided in the electronic instrument (e.g., portable telephone, portable game machine, portable player, or television) detects the angular velocity (vibration) applied to the electronic instrument.

Since the electronic instrument moves when the electronic instrument is hit, the rotational angular velocity corresponding to the hit count is detected.

FIGS. 3A and 3B are diagrams illustrative of the rotational angular velocity according to this embodiment.

FIG. 3A shows an example of an analog signal output from the angular velocity sensor. The angular velocity sensor detects the rotational angular velocity with respect to one specific axis as an analog signal. The analog signal changes corresponding to a change in the operation of the electronic instrument. Reference numeral 220 indicates a change in the voltage value output from the angular velocity sensor when the electronic instrument is rotated to the right, and reference numeral 222 indicates a change in the voltage value output from the angular velocity sensor when the electronic instrument is rotated to the left.

FIG. 3B shows a digital signal obtained by digitally converting the analog signal output from the angular velocity sensor. When the voltage value in a stationary state is 0, the electronic instrument is rotated to the right in an interval 220′ in which the voltage value is positive (+) (right rotation pulse is generated), and the electronic instrument is rotated to the left in an interval 222′ in which the voltage value is negative (−) (left rotation pulse is generated). When the electronic instrument is hit once, a right rotation pulse and a left rotation pulse which make a pair are detected. Therefore, it is possible to detect that the electronic instrument has been hit once by detecting the right rotation pulse and the left rotation pulse which make a pair.

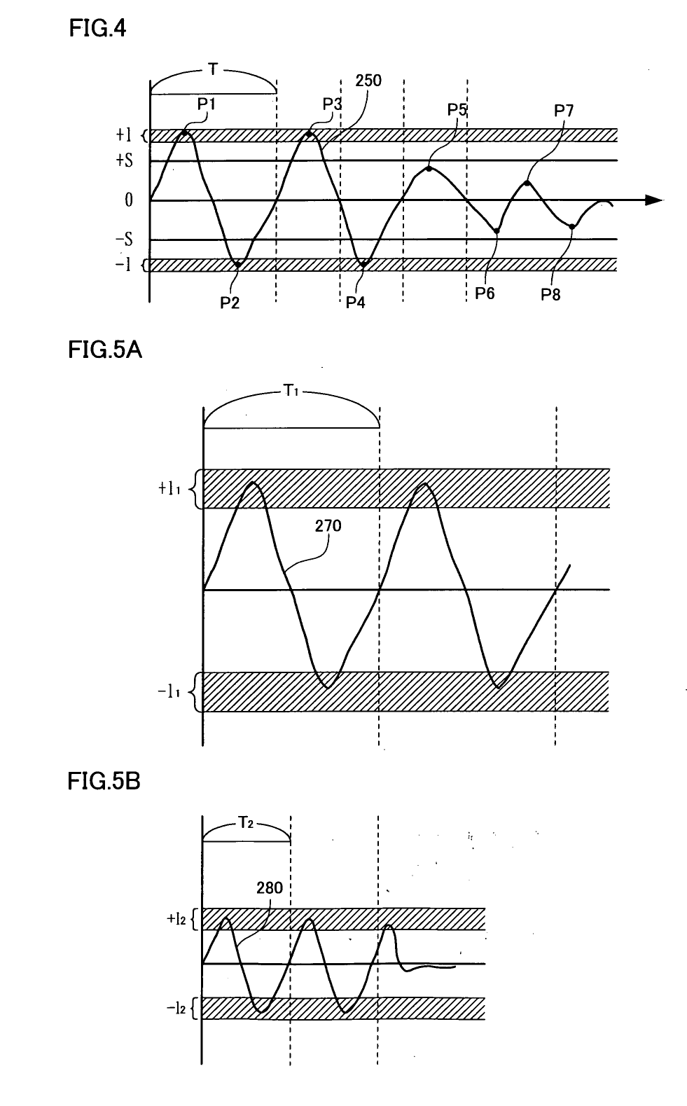

FIG. 4 is a diagram illustrative of hit count determination according to this embodiment.

A signal 250 is a change in rotational angular velocity value detected when the electronic instrument is hit twice (the signal 250 is indicated by a continuous line (analog value) in FIG. 4; the same description also applies to a set of discrete points (digital value)).

The signal 250 which shows a change in rotational angular velocity value has regular pulses having extreme values (maximum value or minimum value) P1, P2, P3, and P4 and derivative pulses having extreme values P5, P6, P7, and P8. The pulses having the extreme values P1 and P2 have occurred due to the first hit operation, and the pulses having the extreme values P3 and P4 have occurred due to the second hit operation. The subsequent irregular pulses (pulses having the extreme values P5, P6, P7, and P8) have occurred due to a shake which occurs as a reaction against the first and second hit operations.

In this embodiment, pulses which occurred due to a hit operation are extracted from the signal 250 which indicates a change in rotational angular velocity value to determine the hit count. Threshold values (+S1 and −S1) for the signal 250 which indicates a change in rotational angular velocity value may be set, a pulse which satisfies the operation event generation condition may be detected based on the threshold value, and the hit count of the electronic instrument may be determined based on the pulse.

For example, the threshold values (+S1 and −S1) may be set, and it may be determined that one hit operation has been performed when a pair of pulses exceeding the threshold values has been detected. In this case, since the signal 250 which indicates a change in rotational angular velocity value shown in FIG. 4 has two pairs of pulses (a pair of pulses having the extreme values P1 and P2 and a pair of pulses having the extreme values P3 and P4) which exceed the threshold values, it is determined that two hit operations have been performed.

Note that extreme value ranges (+1 and −1) which specify the upper limit and the lower limit of the extreme value may be set, and it may be determined that one hit operation has been performed when a pair of pulses of which the extreme values are within the extreme value range has been detected. In this case, since the signal 250 which indicates a change in rotational angular velocity value has two pairs of pulses (a pair of pulses having the extreme values P1 and P2 and a pair of pulses having the extreme values P3 and P4) of which the extreme values are within the extreme value range, it is determined that two hit operations have been performed. According to this configuration, a situation can be prevented in which the electronic instrument operates based on vibrations when the signal 250 which indicates a change in rotational angular velocity value includes a value which exceeds the extreme value range. This makes it possible to prevent malfunction of the electronic instrument.

The hit count determination accuracy can be increased by setting an appropriate operation event generation condition in this manner.

A hit command registration period may be set, and the user may input a hit command in the hit command registration period. The operation event generation condition may be set based on the rotational angular velocity value received in the hit command registration period, and stored as the hit command determination information. The hit count of the electronic instrument may be detected based on the hit command determination information and a change in rotational angular velocity value.

For example, a range (extreme value range) for the extreme value (maximum value or minimum value) of a pulse used to determine occurrence of a hit operation may be set based on the rotational angular velocity value received within the hit command registration period as the operation event generation condition, and whether or not the extreme value of the detected pulse is within the extreme value range may be determined. It may be determined that a hit operation has been performed when the extreme value of the detected pulse is within the extreme value range.

A threshold value used to determine the condition for the extreme value (maximum value and minimum value) of a pulse used to determine occurrence of a hit operation may be set based on the rotational angular velocity value received within the hit command registration period as the operation event generation condition, and whether or not the extreme value of the detected pulse has exceeded the threshold value may be determined. It may be determined that a hit operation has been performed when the extreme value of the detected pulse has exceeded the threshold value.

The characteristics of a cycle (T) used to determine the interval of hit operations may be determined based on the rotational angular velocity value received within the hit command registration period as the operation event generation condition, and a pulse may be detected using the cycle properties.

This enables control so that the command is not executed when a hit operation has been performed in a cycle differing from a cycle during registration.

FIGS. 5A and 5B are diagrams illustrative of the relationship between the rotational angular velocity value detected within the hit command registration period and the hit command determination registration information to be set.

In general, the strength and the speed of the hit operation differ depending on the user even if the hit count is the same. A configuration which absorbs the difference between users and determines the hit count, or a configuration in which a command is registered in user units depending on each user may be employed. Specifically, a hit command registration period may be provided which is a period in which a hit command of each user is registered, and the user performs an operation such as a one-hit operation or two-hit operation in the hit command registration period. The properties (e.g., strength or degree) of the hit operation of each user are detected based on a change in rotational angular velocity value which has occurred due to the operation, and are registered as the hit command determination registration information.

A signal 270 shown in FIG. 5A indicates a change in rotational angular velocity value detected when a user A has performed a two-hit operation, and a signal 280 shown in FIG. 5B indicates a change in rotational angular velocity value detected when a user B has performed a two-hit operation. T1 indicates the cycle of the signal 270, and +11 and −11 indicate the extreme value ranges of the signal 270. T2 indicates the cycle of the signal 280, and +12 and −12 indicate the extreme value ranges of the signal 280.

The absolute value of the extreme values of the signal 270 shown in FIG. 5A is larger than that of the signal 280 shown in FIG. 5B (|11|>|21|), and the cycle of the signal 270 shown in FIG. 5A is longer than that of the signal 280 shown in FIG. 5B (T1>T2). Specifically, the user A slowly and strongly performs the two-hit operation, and the user B quickly and weakly performs the two-hit operation as compared with the user A.

The cycle T1 and extreme value range 11 may be registered in the electronic instrument of the user A as the command determination registration information, and the cycle T2 and extreme value range 12 may be registered in the electronic instrument of the user B as the command determination registration information.

In this case, a command is not executed when the user B has performed the two-hit operation on the electronic instrument of the user A, and a command is not executed when the user A has performed the two-hit operation on the electronic instrument of the user B. Therefore, since the operation of another person is not accepted, an electronic instrument with high security performance can be provided.

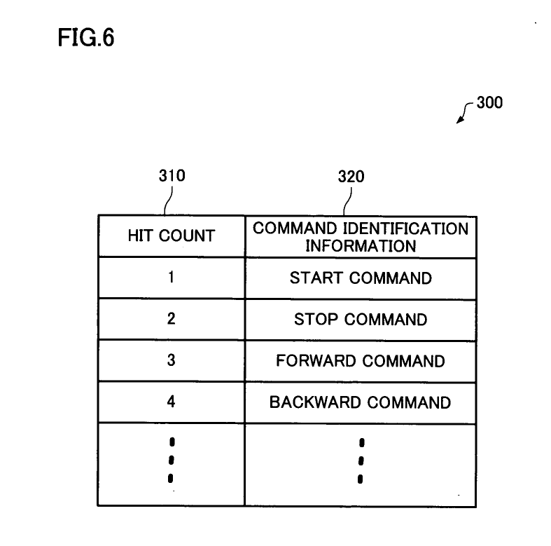

FIG. 6 is a table for describing the correspondence relationship between the hit count and the command.

A table 300 is a command correspondence table which defines the correspondence relationship between the hit count and the command. The command correspondence table 300 stores the hit count and the command identification information which specifies the command corresponding to the hit count.

For example, a start command is associated with a hit count “1”, a stop command is associated with a hit count “2”, a forward command is associated with a hit count “3”, and a backward command is associated with a hit count “4”.

For example, when applying this configuration to a portable music player, the user can reproduce a tune by hitting the electronic instrument once, can stop reproduction of a tune by hitting the electronic instrument twice, can skip forward by hitting the electronic instrument three times, and can skip backward by hitting the electronic instrument four times.

The correspondence relationship between the hit count and the command may be stored in a storage section as a table so that the correspondence relationship can be referred to from a program or the like, or may be incorporated in a program in advance as an instruction code, or may be incorporated in a circuit in advance.

The correspondence relationship between the hit count and the command may be set based on an external input and stored in the correspondence relationship storage section. Specifically, a configuration may be employed in which the correspondence relationship between the hit count and the command can be set or changed based on an input from the user.

This allows the user to set or change the correspondence relationship between the hit count and the command, if necessary. Therefore, each user can set a convenient operation system. Moreover, since the setting differs depending on the user, security is enhanced.

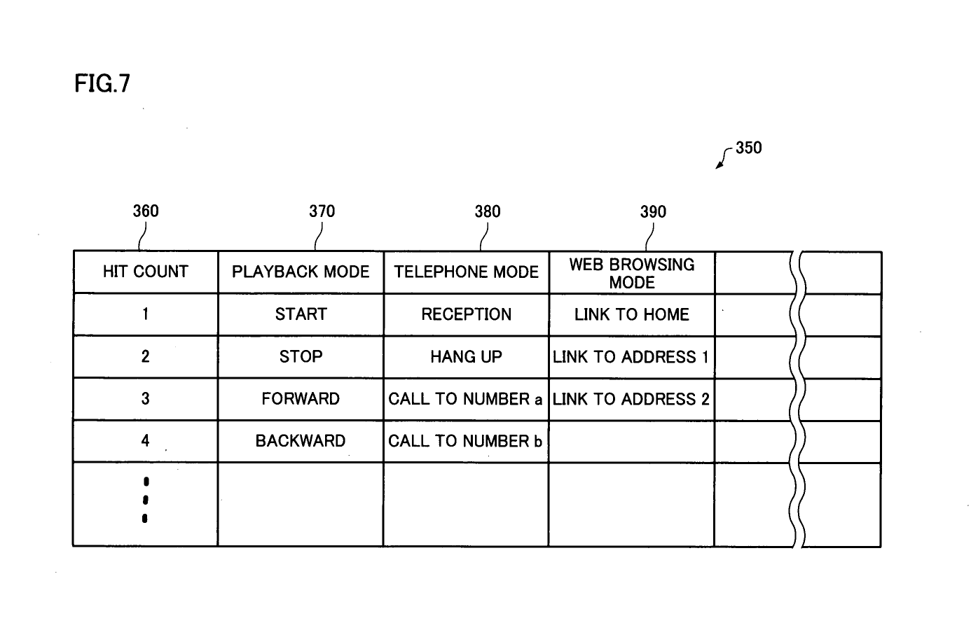

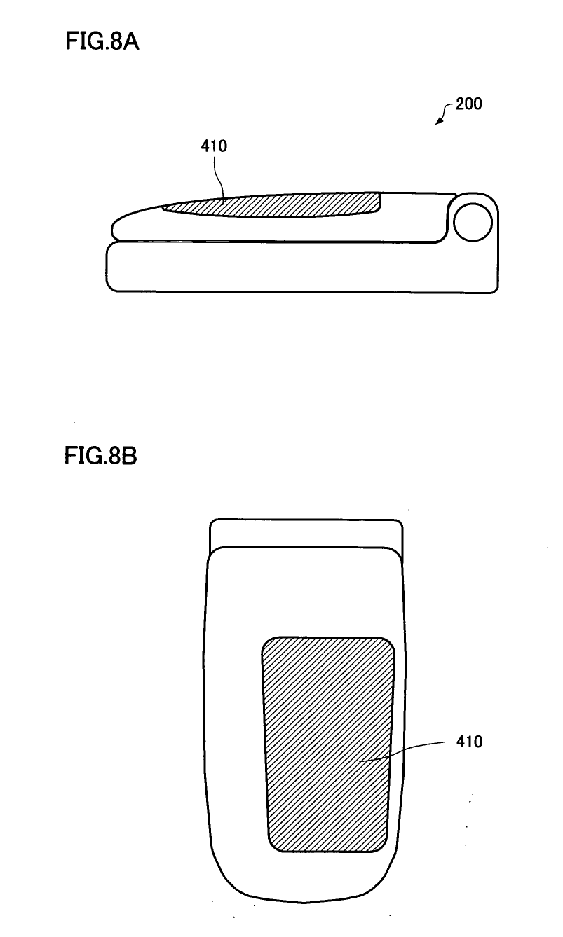

FIG. 7 is a table for describing changing the command to be associated depending on the processing system.

A table 350 is a command correspondence table which stores the correspondence relationship between the hit count and the command in processing system units.

FIG. 7 shows a state in which each command is registered in three processing systems (playback mode 370, telephone mode 380, and web browsing mode 390) while being associated with the hit count.

The present processing system (processing mode) may be stored in a processing mode register or the like. The processing mode register is updated corresponding to the operation record of the user. For example, when the user has selected the playback mode on the menu screen, “1” (value which indicates the playback mode) may be set in the processing mode register. When the user has selected the telephone mode on the menu screen, “2” (value which indicates the telephone mode) may be set in the processing mode register. When the user has selected the web browsing mode on the menu screen, “3” (value which indicates the web browsing mode) may be set in the processing mode register. When executing the hit command, a command to be executed may be determined corresponding to the hit count and the processing mode referring to the processing mode register.

This enables various commands to be executed by performing the hit operation.

FIGS. 8A and 8B are diagram illustrative of an example of the hit area according to this embodiment. The electronic instrument 200 according to this embodiment has a hit area which is provided on the outer side of the electronic instrument 200 and allows the user to input the hit command. The user inputs the hit command by hitting a hit area 410.

The hit count detection section sets the determination condition used to determine the hit count provided that hit area 410 and detects the hit count. The detection sensitivity of the angular velocity sensor can be increased by limiting the hit area.

The electronic instrument 200 may be configured so that the hit area 410 cannot be identified from the outside. This makes it difficult for a person other than the user to accurately vibrate the electronic instrument 200, thereby preventing a person other than the user from utilizing the electronic instrument 200. For example, the electronic instrument 200 may be formed so that the hit area 410 is flush with its peripheral area. Specifically, the hit area 410 and its peripheral area may be formed of the same material. The same color and the same pattern may be provided on the surface of the hit area 410 and the surface of its peripheral area. Specifically, the electronic instrument 200 may be configured so that the area (hit area 410) at which a person other than the user may input operation information does not have a mark which indicates that area (i.e., mark which can be recognized by sight or sense of touch). In other words, the housing of the electronic instrument 200 may be configured so that the housing does not have a mechanism by which the user can identify the hit area.

Note that this embodiment is not limited thereto. The hit area 410 may be configured so that the hit area 410 can be identified from the outside. For example, a contact detection section which detects contact with the hit area 410 may be provided in the hit area 410. The contact detection section may be implemented by a thermosensor, a touch panel, a switch, or the like.

A situation can be prevented in which a command is executed even if a hit operation (i.e., operation which vibrates the electronic instrument 200) is not performed for the hit area by providing a contact detection section which detects contact in the hit area 410. This prevents a situation in which a command is executed against the user's will.

A configuration may be employed in which a hit waveform within a specific period of time may be detected and accepted, even if contact with the hit area 410 has not been detected, and a predetermined command is then executed.

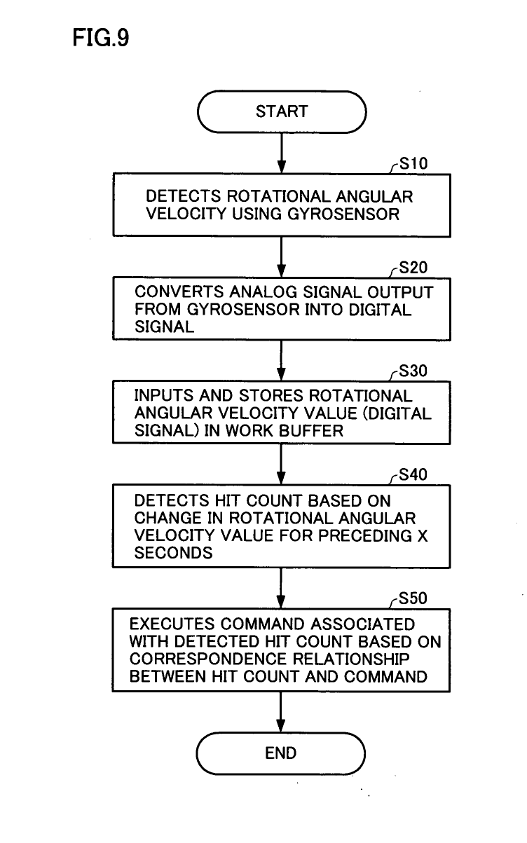

FIG. 9 is a flowchart illustrative of the flow of a process which determines the hit count of the electronic instrument using a rotational angular velocity.

A rotational angular velocity is detected using the gyrosensor (step S10).

An analog signal output from the gyrosensor is then converted into a digital signal (step S20).

The rotational angular velocity value (digital signal) is input to and stored in a work buffer (step S30).

The hit count is then detected based on a change in rotational angular velocity value for the preceding x seconds stored in the work buffer (input data storage section) (step S40).

A command associated with the detected hit count is then executed based on the correspondence relationship between the hit count and the command (step S50).

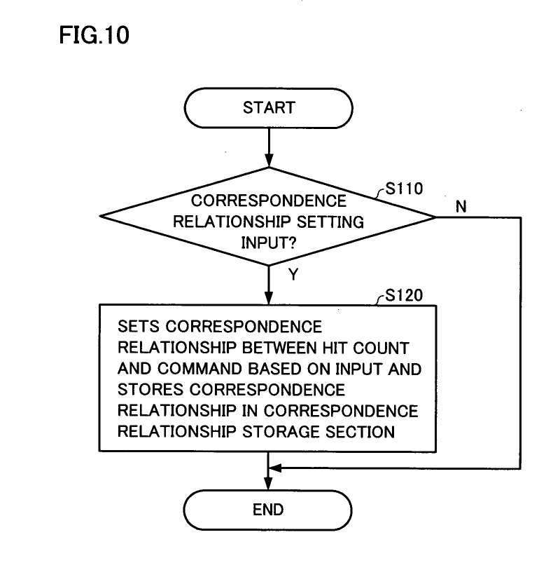

FIG. 10 is a flowchart illustrative of the flow of a process which registers the correspondence relationship between the hit count and the command.

When a correspondence relationship setting input has been received (step S110), the correspondence relationship between the hit count and the command is set based on the input, and stored in the correspondence relationship storage section (step S1120).

The correspondence relationship may be input using the following method. For example, when the user has selected registration of the correspondence relationship from a menu, a selection screen is displayed. When the user has selected the hit count on the selection screen, a list of commands which can be associated with the hit count is displayed, and the user selects a command executed while being associated with the hit count from the list.

The relationship between the hit count and the execution target command can set/changed at any time.

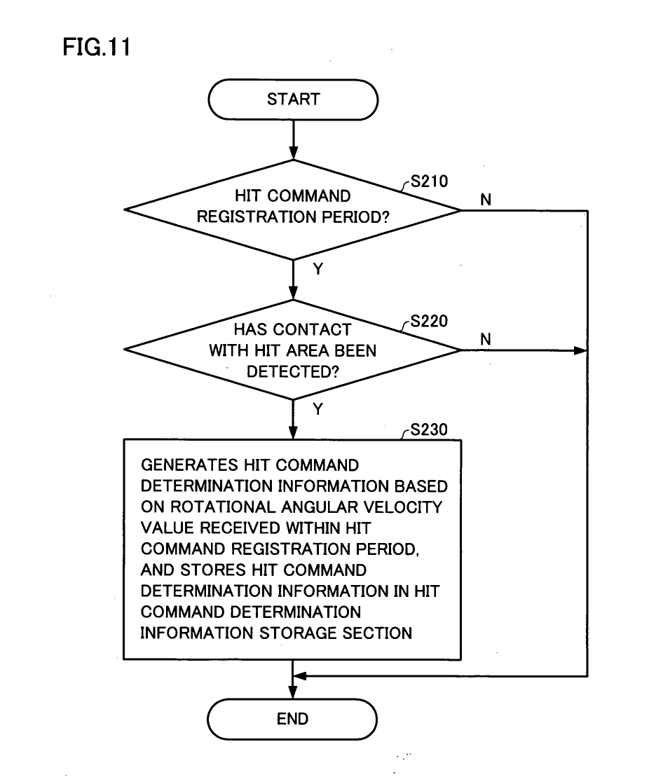

FIG. 11 is a flowchart illustrative of the flow of a hit command determination information registration process.

Whether or not the hit command registration period is occurring is determined. When the hit command registration period is occurring, the following process is performed (step S210).

Specifically, whether or not contact with the hit area has been detected is determined. When contact with the hit area has been detected, the following process is performed (step S220).

Specifically, the hit command determination information is generated based on the rotational angular velocity value received within the hit command registration period, and stored in the hit command determination information storage section (step S230).

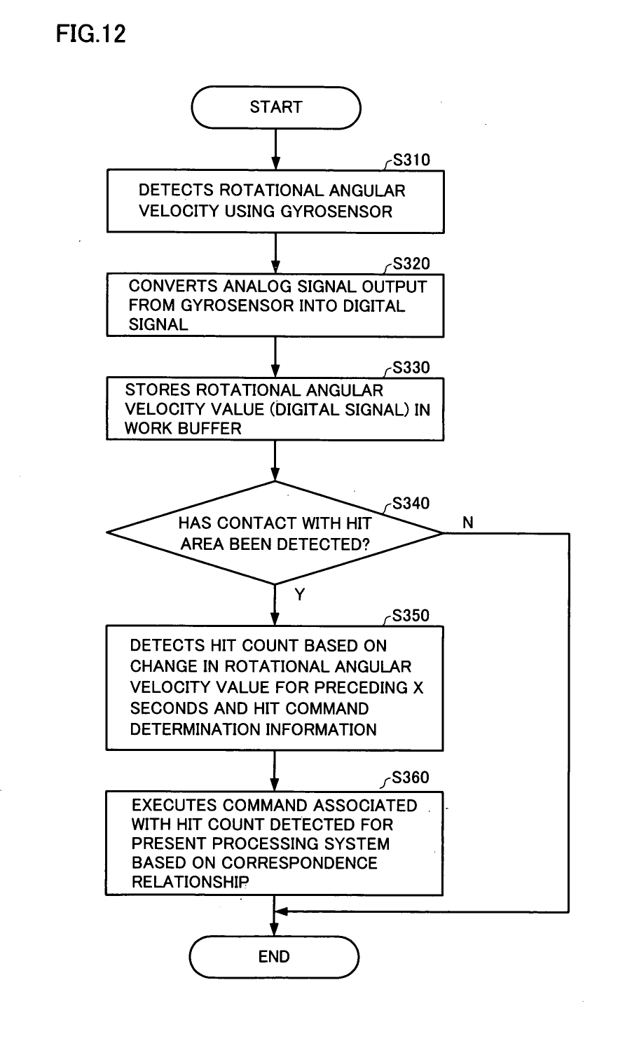

FIG. 12 is a flowchart illustrative of the flow of a process which determines the hit count of the electronic instrument using the hit command determination information.

A rotational angular velocity is detected using the gyrosensor (step S310).

An analog signal output from the gyrosensor is then converted into a digital signal (step S320).

The rotational angular velocity value (digital signal) is input to and stored in the work buffer (step S330).

Whether or not contact with the hit area has been detected is determined. When contact with the hit area has been detected, the following process is performed (step S340).

Specifically, the hit count is detected based on a change in rotational angular velocity value for the preceding x seconds stored in the work buffer and the hit command determination information (step S350).

A command associated with the hit count detected for the present processing system is executed based on the correspondence relationship (step S360).

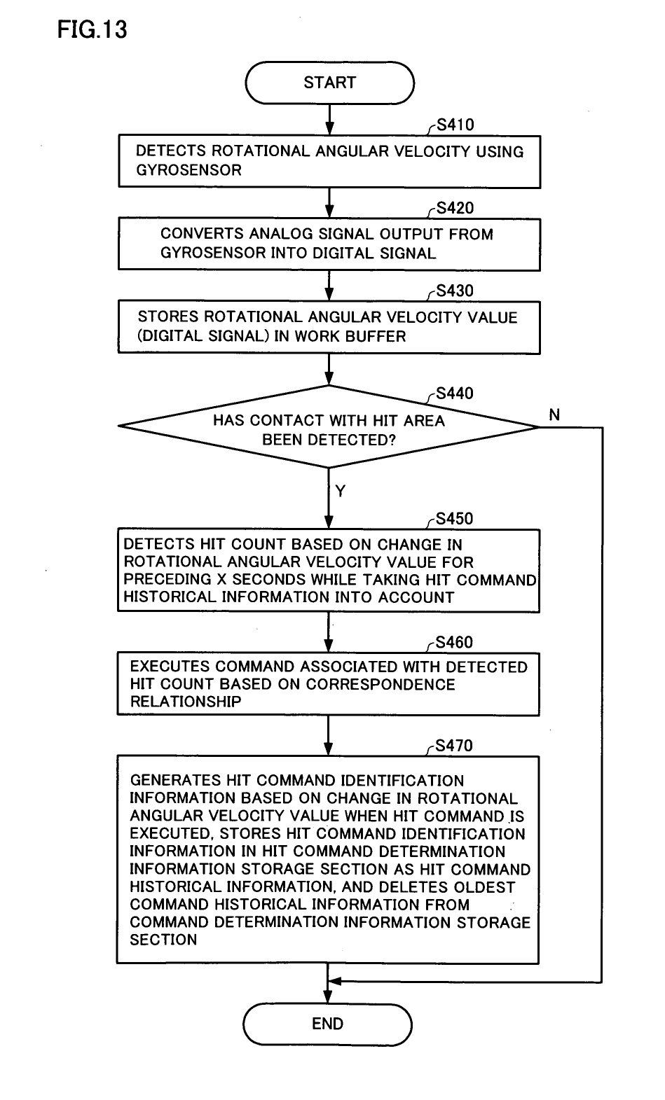

FIG. 13 is a flowchart illustrative of the flow of a hit command detection learning function.

A rotational angular velocity is detected using the gyrosensor (step S410).

An analog signal output from the gyrosensor is then converted into a digital signal (step S420).

The rotational angular velocity value (digital signal) is input to and stored in the work buffer (step S430).

Whether or not contact with the hit area has been detected is determined. When contact with the hit area has been detected, the following process is performed (step S440).

The hit count is then detected based on a change in rotational angular velocity value for the preceding x seconds stored in the work buffer while taking the hit command historical information into account (step S450).

A command associated with the detected hit count is executed based on the correspondence relationship (step S460).

The hit command determination information is generated based on a change in rotational angular velocity value when the hit command is executed, and stored in the hit command determination information storage section as the hit command historical information. The oldest command historical information is deleted from the hit command determination information storage section (step S470).

This embodiment achieves a learning effect by which the user's latest input tendency can be reflected determining the hit count while taking the command historical information into account.

### 2. Second Embodiment

FIG. 15 is a diagram illustrative of a configuration of a hit command processing system according to a second embodiment.

A hit command processing system 610 according to this embodiment includes an angular velocity sensor (gyrosensor) 20 as a vibration detection sensor. The angular rate sensor 620 measures a rotational velocity (rotational angular velocity) with respect to a rotational motion around a specific rotation axis, and outputs an analog signal 22 corresponding to the rotational angular velocity. The angular velocity sensor 620 may be a gyrosensor, for example. The type of gyrosensor is arbitrary. For example, a gyrosensor utilizing a microelectromechanical system (MEMS) technology may be used. The rotational angular velocity with respect to a given axis may be detected, or may be detected with respect to three axes which intersect perpendicularly.

The hit command processing system 610 according to this embodiment includes an analog processing circuit (analog front-end circuit) 630. The analog processing circuit 630 includes a low-pass filter/operational amplifier 32 and an A/D converter 634. The analog processing circuit 630 receives the analog signal 622, and outputs a corresponding digital signal 636.

The hit command processing system 10 according to this embodiment includes an input data storage section 60. The input data storage section 660 holds the input digital signal (rotational angular velocity).

The hit command processing system 610 according to this embodiment includes a hit input detection section 670. The hit input detection section 670 receives a rotational angular velocity value 636 output from the analog processing circuit 630, and determines the presence or absence of a hit input using the electronic instrument based on a change in rotational angular velocity value. For example, the hit input detection section 670 may be implemented by a CPU or a microcomputer including a CPU.

The hit input detection section 670 may determine the presence or absence of a hit input to a plurality of switch areas set at different positions of the electronic instrument based on a change in rotational angular velocity value of one angular velocity sensor.

The hit input detection section 670 may determine the presence or absence of a hit input to a plurality of switch areas set at different positions of the electronic instrument based on a change in rotational angular velocity value of a plurality of angular velocity sensors disposed at different positions of the electronic instrument.

The hit input detection section 670 may detect a pulse which satisfies an operation event generation condition based a change in rotational angular velocity value, and determine the presence or absence of a hit input using the electronic instrument based on the detected pulse.

The hit command processing system 610 according to this embodiment includes a hit command execution section 680. The hit command execution section 680 executes a command associated with the hit input when the hit input has been determined to exist. For example, the hit command execution section 680 may be implemented by a CPU or a microcomputer including a CPU.

When it has been determined that the hit input has been performed for one of the switch areas, the hit command execution section 680 may execute the command associated with that switch area.

The hit command processing system 610 according to this embodiment includes a hit input determination information registration section 690. The hit input registration section 690 generates hit input determination information based on a rotational angular velocity value received within a hit input registration period, and stores the hit input determination information in a hit input determination information storage section 650. For example, the hit input registration section 690 may be implemented by a CPU or a microcomputer including a CPU.

The hit input detection section 670 may determine the presence or absence of a hit input using the electronic instrument based on the hit input determination information and a change in rotational angular velocity value.

The hit input registration section 690 may include a historical information registration section 692. The historical information registration section 692 generates hit input identification information based on a change in rotational angular velocity value when the hit input detection section 670 has determined that the hit input has been performed, and stores the hit input identification information in the hit input determination information storage section 650. The hit input detection section 670 may determine the presence or absence of a hit input or a switch area in which the hit input has been performed taking the hit input historical information into account.

The hit input detection section 670 may set a determination condition used to determine the presence or absence of a hit input provided that the user hits a switch area which is set in part of the electronic instrument for inputting the hit command, and determine the presence or absence of a hit input. The hit input detection section 670 may set a determination condition used to determine the presence or absence of a hit input for each of the switch areas set at different positions of the electronic instrument, and determine the presence or absence of a hit input for each of the switch areas.

The hit command processing system 610 according to this embodiment includes the hit input determination information storage section 650. The hit input determination information storage section 650 stores hit input determination information generated based on a change in rotational angular velocity value when the hit input has been performed for the switch area. When the number of switch areas is two or more, the hit input determination information used to determine the switch area for which the hit input has been performed may be stored in the hit input determination information storage section 50.

For example, the hit input determination information may be a cycle of a change in rotational angular velocity value, an extreme value range, a threshold value of an extreme value, an amplitude direction, an amplitude, or the like.

The hit command determination information storage section 650 may be formed using a rewritable memory such as a flash memory or an EEPROM so that reference data can be set in the rewritable memory based on an external input.

The analog processing circuit 630 may be mounted on a semiconductor integrated circuit device (IC) which implements the hit command processing system 610 according to this embodiment, or may be mounted on another semiconductor integrated circuit device (IC).

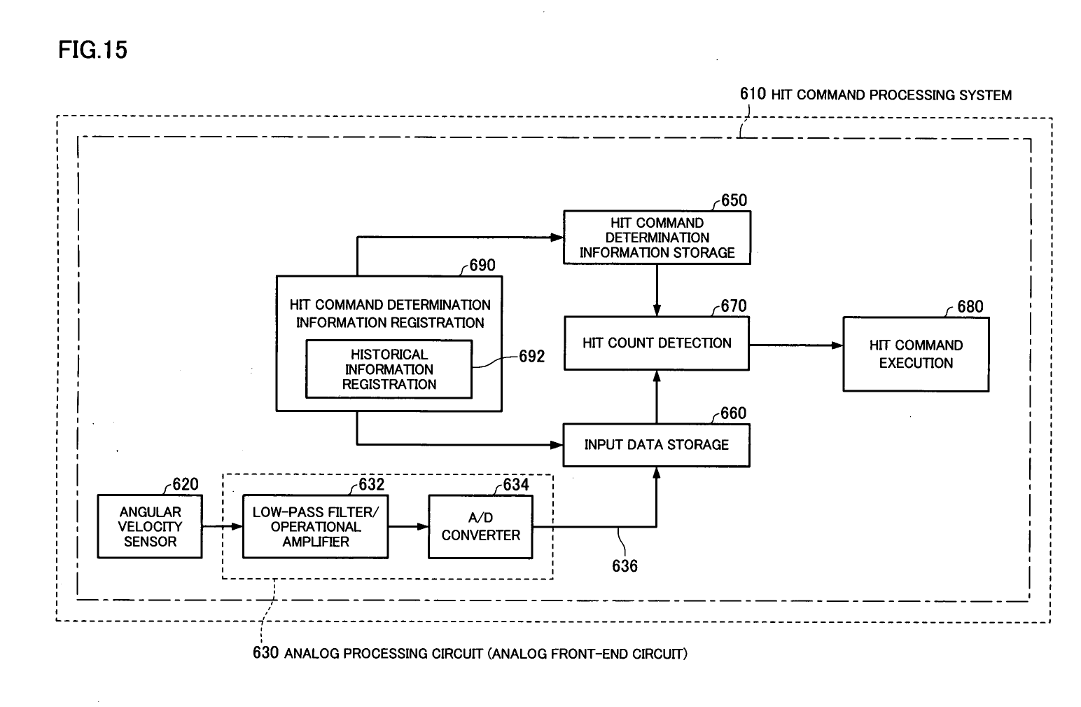

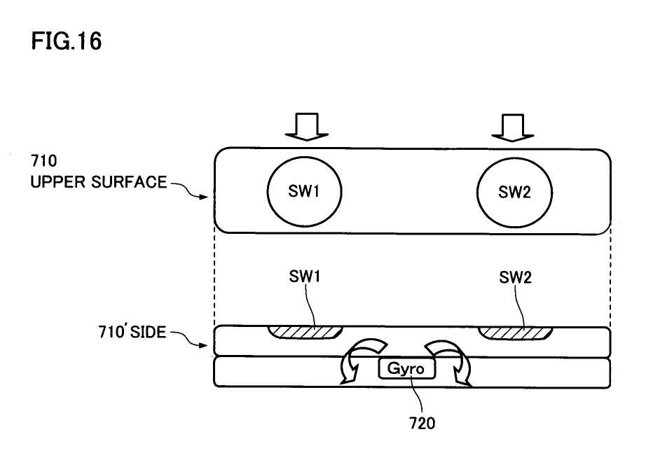

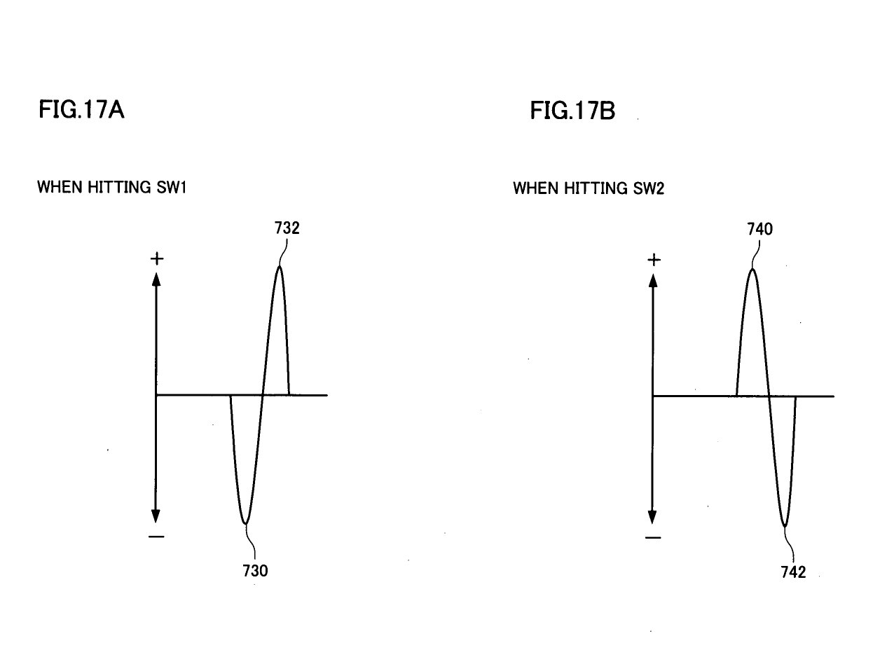

An example of determining the hit inputs using two different switch areas using one gyrosensor is described below. FIG. 16 is a diagram showing the positional relationship between a plurality of switch areas of the electronic instrument and the gyrosensor. FIGS. 17A and 17B are diagrams showing examples of an analog signal output from the gyrosensor when hitting each switch area.

The term “switch area” used herein refers to an area which is hit when the user performs a hit input using the electronic instrument. The switch area may be appropriately set on the surface of the electronic instrument.

In FIG. 16, reference numeral 710 indicates the positional relationship between two switch areas SW1 and SW2 of the electronic instrument when viewed from the upper side, and reference numeral 710′ indicates the positional relationship between the switch areas SW1 and SW2 of the electronic instrument and a gyrosensor 720 when viewed from the side.

In this case, since the rotation direction of the gyrosensor 770 differs depending on the hit position, an analog signal which differs depending on the hit position is obtained.

FIG. 17A shows an example of an analog signal output from the gyrosensor when hitting the switch area SW1, and FIG. 17B shows an example of an analog signal output from the gyrosensor when hitting the switch area SW2. When the switch area SW1 has been hit, a negative pulse 730 with a predetermined amplitude and a positive pulse 732 with a predetermined amplitude are generated in that order (pulses 730 and 732 make a pair). When the switch area SW2 has been hit, a positive pulse 740 with a predetermined amplitude and a negative pulse 742 with a predetermined amplitude are generated in that order (pulses 740 and 742 make a pair).

Since the characteristics (e.g., change in the amplitude direction) of the analog signal obtained differ depending on the positional relationship between the gyrosensor 720 and the switch areas SW1 and SW2, the switch area which has been hit can be determined from the characteristics of the analog signal. For example, when the analog signal indicates that the negative pulse 730 with a predetermined amplitude and the positive pulse 732 with a predetermined amplitude are generated in that order, as shown in FIG. 17A, it may be determined that the hit input has been performed using the switch area SW1. When the analog signal indicates that the positive pulse 740 with a predetermined amplitude and the negative pulse 742 with a predetermined amplitude are generated in that order, as shown in FIG. 17A, it may be determined that the hit input has been performed using the switch area SW2.

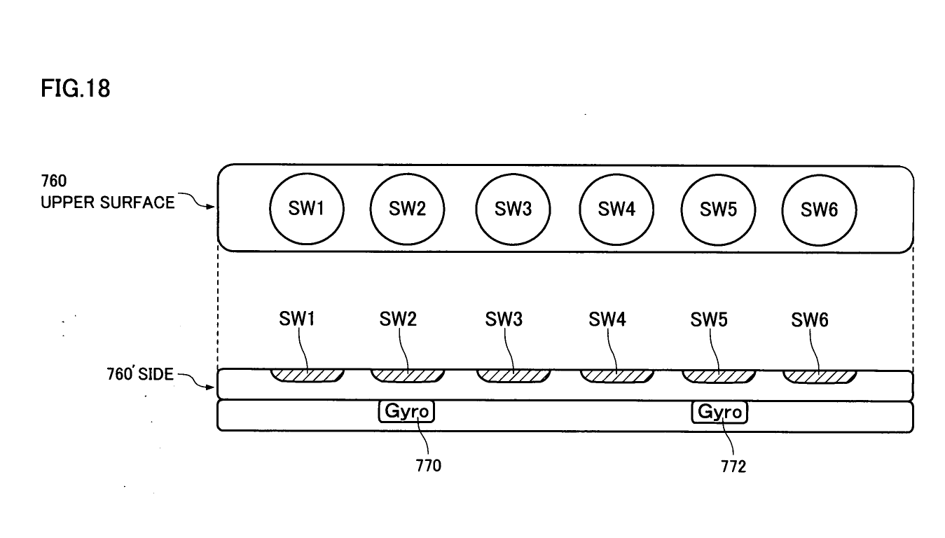

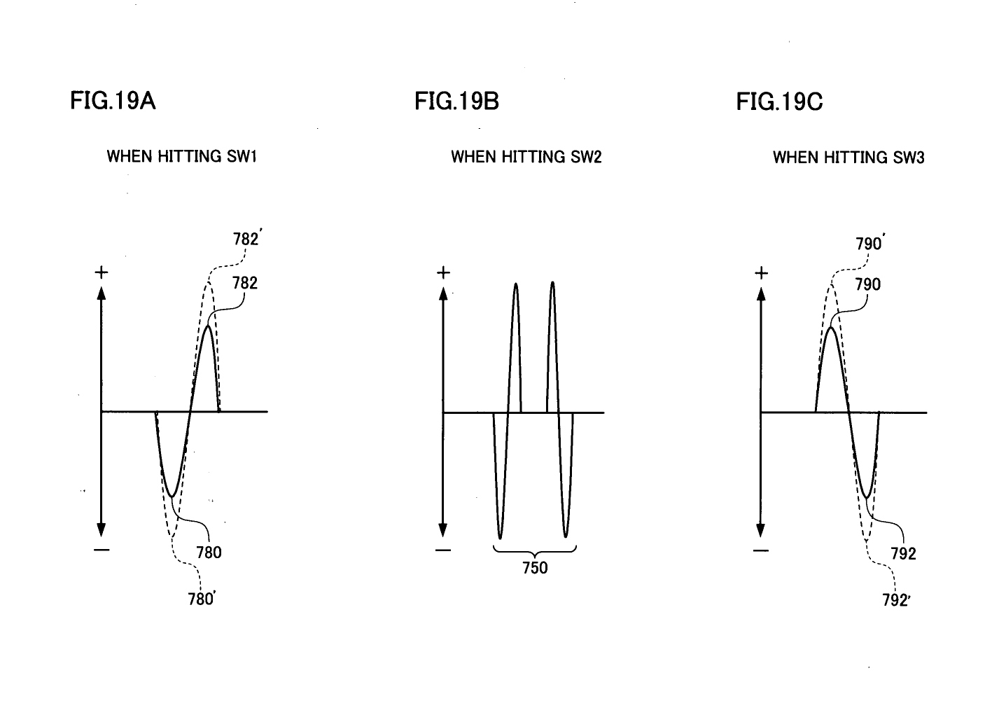

An example of determining the hit inputs using three different switch areas using one gyrosensor is described below. FIG. 18 is a diagram showing the positional relationship between a plurality of switch areas and gyrosensors provided in an electronic instrument. FIGS. 19A to 19C are diagrams showing examples of an analog signal output from the gyrosensor when hitting each switch area.

The term “switch area” used herein refers to an area which is hit when the user performs a hit input using the electronic instrument. The switch area may be appropriately set on the surface of the electronic instrument.

In FIG. 18, reference numeral 760 indicates the positional relationship between three switch areas SW1 to SW3 of the electronic instrument when viewed from the upper side, and reference numeral 760′ indicates the positional relationship between the switch areas SW1 to SW3 of the electronic instrument and a gyrosensor 770 when viewed from the side.

In this case, since the rotation direction of the gyrosensor 770 differs depending on the hit position, an analog signal which differs depending on the hit position is obtained.

FIG. 19A shows an example of an analog signal output from the gyrosensor when hitting the switch area SW1, FIG. 19B shows an example of an analog signal output from the gyrosensor when hitting the switch area SW2, and FIG. 19C shows an example of an analog signal output from the gyrosensor when hitting the switch area SW3. When the switch area SW1 has been hit, a negative pulse 780 with a predetermined amplitude and a positive pulse 782 with a predetermined amplitude are generated in that order (pulses 780 and 782 make a pair). The pulses 780 and 782 have an amplitude smaller to some extent than those of reference pulses 780′ and 782′. When the switch area SW3 has been hit, a positive pulse 790 with a predetermined amplitude and a negative pulse 792 with a predetermined amplitude are generated in that order (pulses 790 and 792 make a pair). The pulses 790 and 792 have an amplitude smaller to some extent than those of reference pulses 790′ and 792′. When the switch area SW2 has been hit, a symmetrical amplitude (unspecified amplitude) 750 is generated.

When the switch areas SW4 to SW6 have been hit, a signal is not output from the gyrosensor 770 since a rotational motion does not occur in the gyrosensor 770 even if vibrations are transmitted. Since a rotational motion occurs in a gyrosensor 772 when the switch areas SW4 to SW6 have been hit, whether or not the switch areas SW4 to SW6 have been hit may be determined based on an analog signal from the gyrosensor 772.

Since the characteristics (e.g., change in the amplitude direction or amplitude) of the analog signal obtained differ depending on the positional relationship between the gyrosensor 770 and the switch areas SW1 to SW3, the switch area which has been hit can be determined from the characteristics of the analog signal. For example, when the analog signal indicates that the negative pulse 780 with a predetermined amplitude (pulse of which the amplitude is smaller than the reference pulse) and the positive pulse 782 with a predetermined amplitude (pulse of which the amplitude is smaller than the reference pulse) are generated in that order (pulses 780 and 782 make a pair), as shown in FIG. 19A, it may be determined that a hit input has been performed using the switch area SW1. For example, when the analog signal indicates that the positive pulse 790 with a predetermined amplitude (pulse of which the amplitude is smaller than that of the reference pulse) and the negative pulse 792 with a predetermined amplitude (pulse of which the amplitude is smaller than that of the reference pulse) are generated in that order (pulses 790 and 792 make a pair), as shown in FIG. 19C, it may be determined that a hit input has been performed using the switch area SW3. For example, when the analog signal indicates that the symmetrical amplitude (unspecified amplitude) 750 of which the amplitude is the same as that of the reference pulse is generated, as shown in FIG. 19B, it may be determined that a hit input has been performed using the switch area SW2.

An example in which a hit input is detected in a state in which the gyrosensors and the switch areas are disposed on a flat surface is described below.

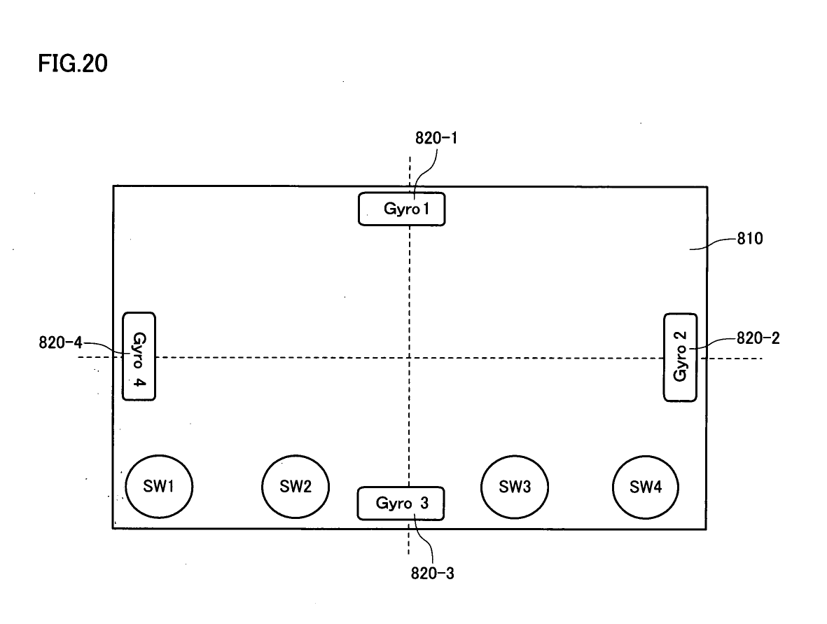

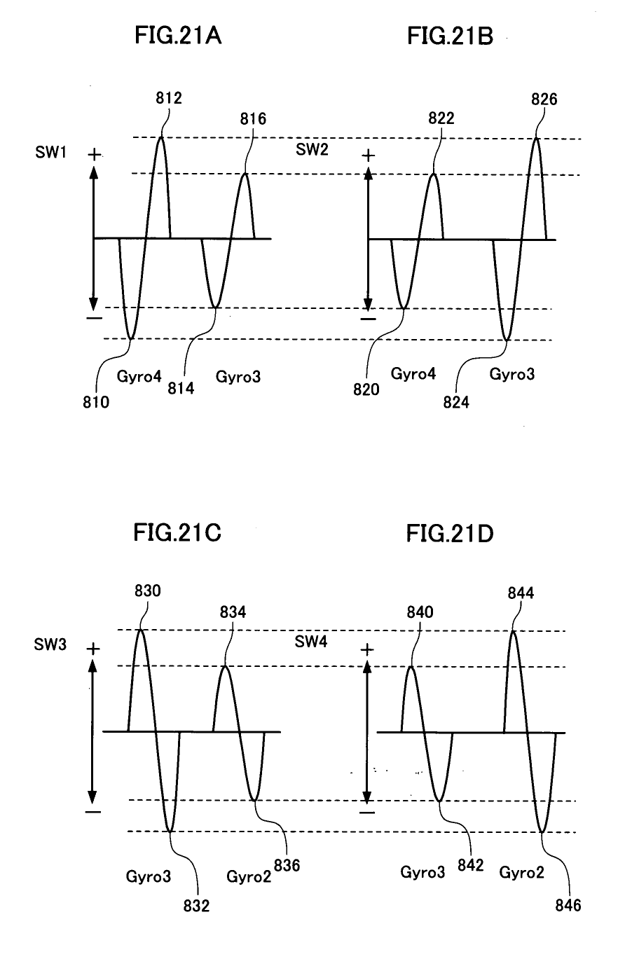

FIG. 20 is a diagram showing the positional relationship between a plurality of switch areas and a plurality of gyrosensor provided on a flat surface of an electronic instrument. FIGS. 21A to 21D are diagrams showing examples of an analog signal output from the gyrosensors when hitting each switch area.

The term “switch area” used herein refers to an area which is hit when the user performs a hit input using the electronic instrument. The switch area may be appropriately set on the flat surface of the electronic instrument.

FIG. 20 is a diagram showing the positional relationship between four switch areas SW1 to SW4 and four gyrosensors 820-1 to 820-4 provided on a flat surface 810 of an electronic instrument. The term “flat surface” may be a surface including a display screen of a flat-screen television or an inner or outer surface disposed in parallel to a display screen, for example.

In this case, the rotation direction and the amplitude of each of the gyrosensors 820-1 to 820-4 differ depending on the hit position.

FIG. 21A shows examples of analog signals output from the gyrosensor 4 (820-4) and the gyrosensor 3 (820-3) when hitting the switch area SW1. When the switch area SW1 has been hit, a negative pulse 810 with a first amplitude and a positive pulse 812 with the first amplitude are generated in that order (pulses 810 and 812 make a pair) from the gyrosensor 4 (820-4; left position near the switch area 1).

A negative pulse 814 with a second amplitude and a positive pulse 816 with the second amplitude (of which the amplitude is smaller than those of the pulses 810 and 812) are generated in that order (pulses 814 and 816 make a pair) from the gyrosensor 3 (820-3; right position apart from the switch area 1).

The direction of the waveform is appropriately adjusted by the installation direction when mounting the gyrosensor on a board. For example, when it is desired to cause analog signals in the same direction to be output from the gyrosensor 4 (820-4) and the gyrosensor 3 (820-3) when hitting the switch area SW1, the installation direction of the gyrosensors may be adjusted so that signals in the same direction are output.

FIG. 21B shows examples of analog signals output from the gyrosensor 4 (820-4) and the gyrosensor 3 (820-3) when hitting the switch area SW2. When the switch area SW2 has been hit, a negative pulse 820 with the second amplitude and a positive pulse 822 with the second amplitude are generated in that order (pulses 820 and 822 make a pair) from the gyrosensor 4 (820-4; left position apart from the switch area 2).

A negative pulse 824 with the first amplitude and a positive pulse 826 with the first amplitude (of which the amplitude is larger than those of the pulses 820 and 822) are generated in that order (pulses 824 and 826 make a pair) from the gyrosensor 3 (820-3; right position near the switch area 2).

FIG. 21C shows examples of analog signals output from the gyrosensor 3 (820-3) and the gyrosensor 2 (820-2) when hitting the switch area SW3. When the switch area SW3 has been hit, a positive pulse 830 with the first amplitude and a negative pulse 832 with the first amplitude are generated in that order (pulses 830 and 832 make a pair) from the gyrosensor 3 (820-3; left position near the switch area 3). A positive pulse 834 with the second amplitude (smaller than the first amplitude) and a negative pulse 836 with the second amplitude (of which the amplitude is smaller than those of the pulses 830 and 832) are generated in that order (pulses 834 and 836 make a pair) from the gyrosensor 2 (820-2; right position apart from the switch area 3).

FIG. 21D shows examples of analog signals output from the gyrosensor 3 (820-3) and the gyrosensor 2 (820-2) when hitting the switch area SW4. When the switch area SW4 has been hit, a positive pulse 840 with the second amplitude and a negative pulse 842 with the second amplitude are generated in that order (pulses 840 and 842 make a pair) from the gyrosensor 3 (820-3; left position apart from the switch area 4). A positive pulse 844 with the first amplitude (smaller than the second amplitude) and a negative pulse 846 with the first amplitude (of which the amplitude is larger than those of the pulses 840 and 842) are generated in that order (pulses 844 and 846 make a pair) from the gyrosensor 2 (820-2; right position near the switch area 4).

Since the amplitude directions (including the generation order of positive and negative pulses) and the amplitudes of the analog signals output from the gyrosensors differ depending on the switch area to be hit, the hit switch area can be determined based on the amplitude directions (including the generation order of positive and negative pulses) and the amplitudes of the analog signals output from the gyrosensors.

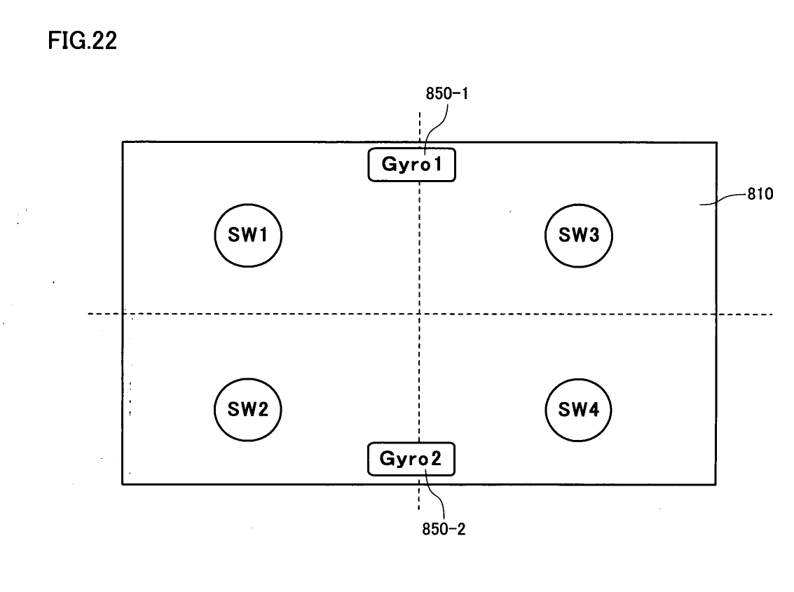

FIG. 22 is a diagram showing the positional relationship between four switch areas SW1 to SW4 and two gyrosensors 850-1 and 850-2 provided on the flat surface 810 of the electronic instrument.

In this case, the rotation direction and the amplitude of each of the gyrosensors 850-1 and 850-2 differ depending on the hit position.

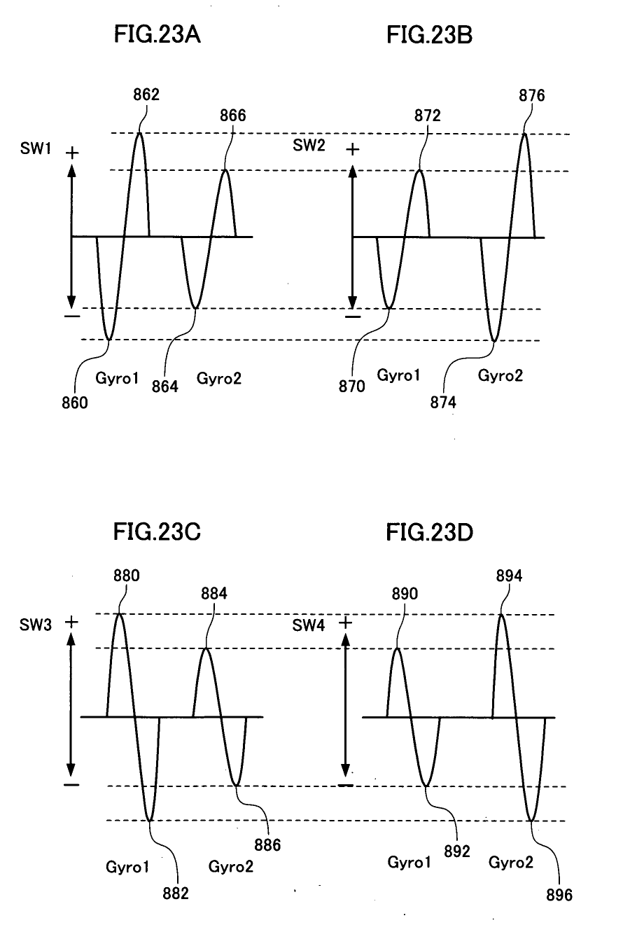

FIG. 23A shows examples of analog signals output from the gyrosensor 1 (850-1) and the gyrosensor 2 (850-2) when hitting the switch area SW1. When the switch area SW1 has been hit, a negative pulse 860 with the first amplitude and a positive pulse 862 with the first amplitude are generated in that order (pulses 860 and 862 make a pair) from the gyrosensor 1 (850-1; right position near the switch area 1). A negative pulse 864 with the second amplitude (smaller than first amplitude) and a positive pulse 866 with the second amplitude (of which the amplitude is smaller than those of the pulses 810 and 812) are generated in that order (pulses 864 and 866 make a pair) from the gyrosensor 2 (850-2; right position apart from the switch area 1).

FIG. 23B shows examples of analog signals obtained from the gyrosensor 1 (850-1) and the gyrosensor 2 (850-2) when hitting the switch area SW2. When the switch area SW2 has been hit, a negative pulse 870 with the second amplitude and a positive pulse 872 with the second amplitude are generated in that order (pulses 870 and 872 make a pair) from the gyrosensor 1 (850-1; right position apart from the switch area 2). A negative pulse 874 with the first amplitude (smaller than second amplitude) and a positive pulse 876 with the first amplitude (of which the amplitude is smaller than those of the pulses 870 and 872) are generated in that order (pulses 874 and 876 make a pair) from the gyrosensor 2 (850-2; right position near the switch area 2).

FIG. 23C shows examples of analog signals obtained from the gyrosensor 1 (850-1) and the gyrosensor 2 (850-2) when hitting the switch area SW3. When the switch area SW3 has been hit, a positive pulse 880 with the first amplitude and a negative pulse 882 with the first amplitude are generated in that order (pulses 880 and 882 make a pair) from the gyrosensor 1 (850-1; left position near the switch area 3). A positive pulse 884 with the second amplitude (smaller than those of the first amplitude) and a negative pulse 886 with the second amplitude (of which the amplitude is smaller than those of the pulses 880 and 882) are generated in that order (pulses 884 and 886 make a pair) from the gyrosensor 2 (820-2; left position apart from the switch area 3).

FIG. 23D shows examples of analog signals obtained from the gyrosensor 1 (850-1) and the gyrosensor 2 (850-2) when hitting the switch area SW4. When the switch area SW4 has been hit, a positive pulse 890 with the second amplitude and a negative pulse 892 with the second amplitude are generated in that order (pulses 890 and 892 make a pair) from the gyrosensor 1 (850-1; left position apart from the switch area 4). A positive pulse 894 with the first amplitude (smaller than the second amplitude) and a negative pulse 896 with the first amplitude (of which the amplitude is larger than those of the pulses 890 and 892) are generated in that order (pulses 894 and 896 make a pair) from the gyrosensor 2 (820-2; left position near the switch area 4).

When the arrangement relationship between the gyrosensor and the switch area is changed, the characteristics (e.g., amplitude direction and amplitude) of the analog signal used to determine whether or not each switch area has been hit differ. Therefore, the characteristics of the analog signals output from the gyrosensors when hitting each switch area may be determined in advance corresponding to the arrangement relationship between the gyrosensors and the switch areas, and a condition used to determine the hit switch area may be set.

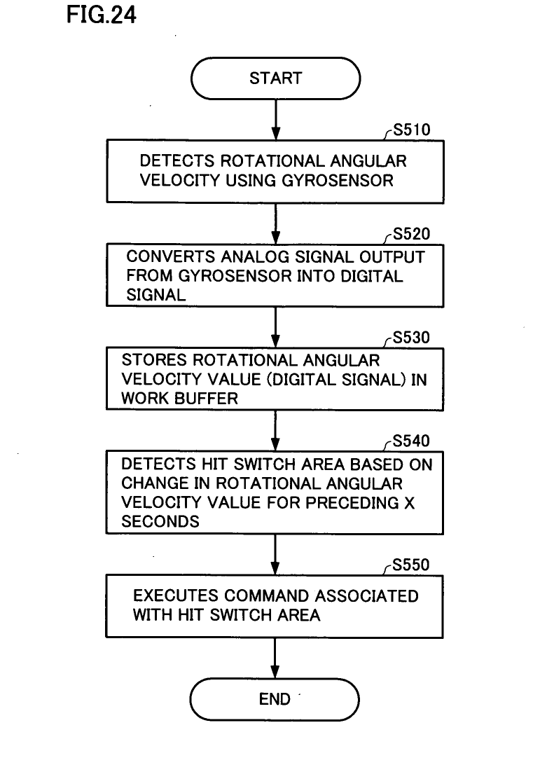

FIG. 24 is a flowchart illustrative of the flow of a process which determines the presence or absence of a hit input using an electronic instrument utilizing a rotational angular velocity.

A rotational angular velocity is detected using the gyrosensor (step S510).

An analog signal output from the gyrosensor is then converted into a digital signal (step S520).

The rotational angular velocity value (digital signal) is input to and stored in the work buffer (step S530).

The switch area which has been hit is determined based on a change in rotational angular velocity value for the preceding x seconds stored in the work buffer (input data storage section) (step S540). The switch area may be determined based on a change in the amplitude direction of the analog signal (or digital signal obtained by subjecting the analog signal to A/D conversion) output from one gyrosensor, as described with reference to FIGS. 17A and 17B, or may be determined based on a change in the amplitude direction and the amplitude of the analog signal (or digital signal obtained by subjecting the analog signal to A/D conversion) output from one gyrosensor, as described with reference to FIGS. 19A to 19C, for example. The switch area may be determined based on the combination of changes in the amplitude directions and the amplitudes of the analog signals (or digital signal obtained by subjecting the analog signal to A/D conversion) output from a plurality of gyrosensors, as described with reference to FIGS. 21A to 21D and FIGS. 23A to 23D, for example.

A command associated with the hit switch area is then executed (step S550).

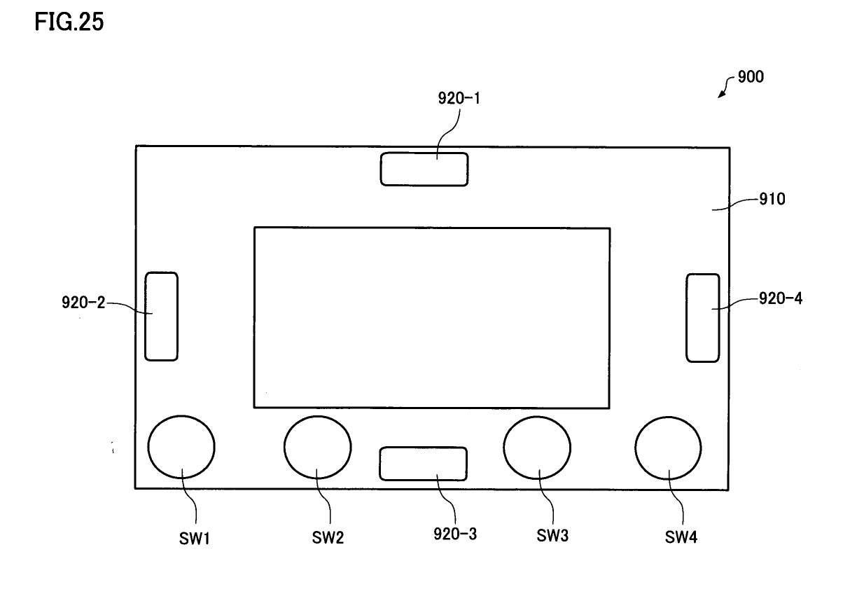

FIG. 25 is a diagram illustrative of an example of operating a flat-screen television using a hit input.

As shown in FIG. 25, four switch areas SW1 to SW4 may be provided on a housing including a surface (corresponding to the flat surface shown in FIG. 20) including a display section 910 of a flat-screen television 900 (e.g., LCD display) so that an input operation can be performed on the flat-screen television by hitting the switch area.

Gyrosensors may be disposed as shown in FIG. 20 or 22, or may be disposed in another arrangement configuration, for example. Since production is facilitated by disposing the gyrosensor between the switch areas, the gyrosensor may be provided between the switch areas.

For example, the first switch area SW1 may be used as a hit input area used to turn the volume up, and the volume may be turned up in one stage when the first switch area SW1 is hit once. Specifically, the first switch area SW1 may be associated with a one-stage volume-up command, and the one-stage volume-up command may be executed when it has been determined that the first switch area SW1 has been hit once.

For example, the second switch area SW2 may be used as a hit input area used to turn the volume down, and the volume may be turned down in one stage when the second switch area SW2 is hit once. Specifically, the second switch area SW2 may be associated with a one-stage volume-down command, and the one-stage volume-down command may be executed when it has been determined that the second switch area SW2 has been hit once.

For example, the third switch area SW3 may be used as a hit input area used to indicate channel-up, and channel-up in one stage may occur when the third switch area SW3 is hit once. Specifically, the third switch area SW3 may be associated with a channel-up command, and the channel-up command may be executed when it has been determined that the third switch area SW3 has been hit once.

For example, the fourth switch area SW4 may be used as a hit input area used to indicate channel-down, and channel-down in one stage may occur when the fourth switch area SW4 is hit once. Specifically, the fourth switch area SW4 may be associated with a channel-down command, and the channel-down command may be executed when it has been determined that the fourth switch area SW4 has been hit once.

This enables a switch to be provided to the housing of the flat-screen television or the like without using an electric switch. Therefore, since a wiring region need not be taken into consideration differing from a configuration in which an electric switch is provided, the housing of the flat-screen television can be made thinner.

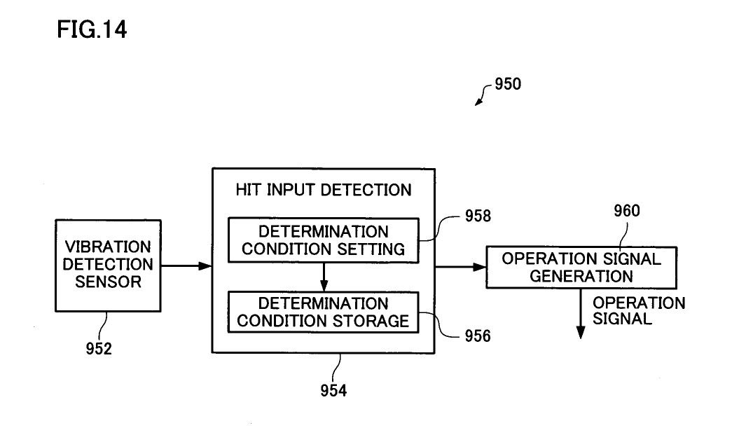

FIG. 14 is a block diagram showing the configuration of an electronic instrument according to one embodiment of the invention. An electronic instrument 950 includes a vibration detection sensor 952. The vibration detection sensor 952 is provided in the electronic instrument 950, and detects vibrations of the electronic instrument 950. An angular velocity sensor may be used as the vibration detection sensor 952. The vibration detection sensor 952 may output an analog signal corresponding to the vibration state of the electronic instrument 950.

The electronic instrument 950 includes a hit input detection section 954 determines whether or not the user has performed a hit input using the electronic instrument 950 based on the output signal from the vibration detection sensor 952. The hit input detection section 954 may include a determination condition storage section 956 which stores a determination condition used to determine that a hit input has been performed using the electronic instrument 950, and may determine the presence or absence of a hit input based on the determination condition stored in the determination condition storage section 956. The hit input detection section 954 may further include a determination condition setting section 958 which stores the determination condition in the determination condition storage section 956. The determination condition setting section 958 may set the determination condition based on the hit input performed using the electronic instrument 950 in a determination condition setting registration period. This enables the electronic instrument to be configured so that the electronic instrument can be operated using a hit input only when the electronic instrument 950 is installed in a predetermined state and a hit input with a specific strength has been performed for a specific area of the electronic instrument 950. This makes it possible to prevent malfunction of the electronic instrument.

The electronic instrument 950 includes an operation signal generation section 960. The operation signal generation section 960 generates an operation signal corresponding to the hit input detected by the hit input detection section 954. When the electronic instrument 950 has a plurality of switch areas, the operation signal generation section 960 may have data which indicates the correspondence relationship between the hit switch area and the operation signal, and may output an operation signal corresponding to the hit switch area based on the data. This makes it possible to cause the electronic instrument to perform various operations by a simple operation of hitting the switch area provided on the electronic instrument.

The invention is not limited to the above-described embodiments. Various modifications and variations may be made without departing from the scope of the invention.

For example, the above embodiments have been given taking an example in which the hit count is determined using a rotational angular velocity relating to one axis. Note that the invention is not limited thereto. For example, a motion command may be detected by detecting a rotational angular velocity relating to each of three axes.

The above embodiments have been given taking an example in which a change in voltage value is output from the angular velocity sensor as an analog signal. Note that the invention is not limited thereto. For example, a change in current value may be output from the angular velocity sensor as an analog signal.

The above embodiments have been given taking a portable telephone, a portable player, or a flat-screen television as an example of the electronic instrument. Note that the invention is not limited thereto. For example, the electronic instrument may be a controller used to operate a main body separately provided from the controller. In this case, a controller which enables a hit input can be provided.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. A hit command processing system for an electronic instrument, the hit command processing system comprising:
an angular velocity sensor which detects a rotational angular velocity and outputs an analog signal corresponding to the rotational angular velocity;
an analog processing circuit which receives the analog signal output from the angular velocity sensor, converts the analog signal into a digital signal, and outputs the digital signal as a rotational angular velocity value;
a hit input detection section which receives the rotational angular velocity value output from the analog processing circuit, and determines whether or not a hit input is performed to an electronic instrument based on a change in the rotational angular velocity value; and
a hit command execution section which executes a command associated with the hit input when the hit input detection section has determined that the hit input has been performed.

2. The hit command processing system as defined in claim 1,
wherein the hit input detection section includes a hit count detection section receiving the rotational angular velocity value output from the analog processing circuit and determining a hit count of the electronic instrument based on a change in the rotational angular velocity value; and
wherein the hit command execution section includes a correspondence relationship storage section storing a correspondence relationship between the hit count and the command, and executes the command associated with the determined hit count based on the correspondence relationship.

3. A hit command processing system for an electronic instrument, the hit command processing system comprising:
a hit input detection section which determines whether or not a hit input is performed based on a change in a rotational angular velocity value; and
a hit command execution section which executes a command associated with the hit input when the hit input detection section has determined that the hit input has been performed.

4. The hit command processing system as defined in claim 3,
wherein the hit input detection section includes a hit count detection section determining a hit count of the electronic instrument based on a change in the rotational angular velocity value; and
wherein the hit command execution section includes a correspondence relationship storage section storing a correspondence relationship between the hit count and the command, and executes the command associated with the determined hit count based on the correspondence relationship.

5. The hit command processing system as defined in claim 1,
wherein the hit input detection section determines whether or not the hit input is performed to a plurality of switch areas respectively set at different positions of the electronic instrument based on a change in a rotational angular velocity value of one angular velocity sensor; and
wherein, when the hit input detection section has determined that the hit input has been performed to a switch area among the switch areas, the hit command execution section executes the command associated with the switch area.

6. The hit command processing system as defined in claim 3,
wherein the hit input detection section determines whether or not the hit input is performed to a plurality of switch areas respectively set at different positions of the electronic instrument based on a change in a rotational angular velocity value of one angular velocity sensor; and
wherein, when the hit input detection section has determined that the hit input has been performed to a switch area among the switch areas, the hit command execution section executes the command associated with the switch area.

7. The hit command processing system as defined in claim 1,
wherein the hit input detection section determines whether or not the hit input is performed to a plurality of switch areas respectively set at different positions of the electronic instrument based on a change in rotational angular velocity values of a plurality of the angular velocity sensors respectively disposed at different positions of the electronic instrument; and
wherein, when the hit input detection section has determined that the hit input has been performed to a switch area among the switch areas, the hit command execution section executes the command associated with the switch area.

8. The hit command processing system as defined in claim 3,
wherein the hit input detection section determines whether or not the hit input is performed to a plurality of switch areas respectively set at different positions of the electronic instrument based on a change in rotational angular velocity values of a plurality of the angular velocity sensors respectively disposed at different positions of the electronic instrument; and
wherein, when the hit input detection section has determined that the hit input has been performed to a switch area among the switch areas, the hit command execution section executes the command associated with the switch area.

9. The hit command processing system as defined in claim 4, further comprising:
a correspondence relationship setting section which sets the correspondence relationship between the hit count and the command based on an external input, and causes the correspondence relationship storage section to store the correspondence relationship.

10. The hit command processing system as defined in claim 4,
setting a hit command registration period; and
further comprising a hit command determination information registration section which generates hit command determination information based on the rotational angular velocity value received within the hit command registration period, and causes a hit command determination information storage section to store the generated hit command determination information,
wherein the hit count detection section determines the hit count of the electronic instrument based on the hit command determination information and a change in the rotational angular velocity value.

11. The hit command processing system as defined in claim 4,
wherein the hit count detection section detects a pulse which satisfies an operation event generation condition based on a change in the rotational angular velocity value, and determines the hit count of the electronic instrument based on the pulse.

12. The hit command processing system as defined in claim 4,
wherein the correspondence relationship storage section stores the correspondence relationship between the hit count and the command in processing system units; and
wherein the hit command execution section includes processing system switch means for switching between a plurality of processing systems, and executes the command associated with the hit count determined for a present processing system based on the correspondence relationship.

13. The hit command processing system as defined in claim 4,
wherein the hit command execution section includes means enabling or disabling the command, and executes the command associated with the determined hit count when the command is enabled.

14. The hit command processing system as defined in claim 10,
wherein the hit command determination information registration section includes a historical information registration section generating the hit command determination information based on a change in the rotational angular velocity value when the command has been executed and causing the hit command determination information storage section to store the hit command identification information as command historical information; and
wherein the hit count detection section includes a history reflection processing section which determines the hit count taking the command historical information into account.

15. The hit command processing system as defined in claim 4, further comprising:
a hit area to which the command is input outside the electronic instrument,
wherein the hit count detection section sets a determination condition for determining the hit count assuming that the hit area is hit, and determines the hit count.

16. The hit command processing system as defined in claim 15, further comprising:
a contact detection section which detects contact with the hit area,
wherein the hit count detection section determines the hit count based on a change in the rotational angular velocity value acquired in a period in which contact with the hit area is being detected.

17. The hit command processing system as defined in claim 3, further comprising:
a grip section which is provided outside the electronic instrument and can be held by a user; and
a contact detection section which detects contact with the grip section,
wherein the hit count detection section determines the hit count based on a change in the rotational angular velocity value acquired in a period in which contact with the grip section is being detected.

18. An operation system for an electronic instrument, the operation system comprising:
a vibration detection sensor which detects vibrations of the electronic instrument;
a hit input detection section which determines whether or not a hit input is performed to the electronic instrument based on an output signal from the vibration detection sensor; and
an operation signal generation section which generates an operation signal which operates the electronic instrument depending on whether or not the hit input is performed.

19. An electronic instrument operating based on an operation signal, the electronic instrument comprising:
a vibration detection sensor which detects vibrations of the electronic instrument;
a hit input detection section which determines whether or not a hit input is performed to the electronic instrument based on an output signal from the vibration detection sensor; and
an operation signal generation section which generates an operation signal which operates the electronic instrument depending on whether or not the hit input is performed.

20. The electronic instrument as defined in claim 19, further comprising:
a housing having no mechanism causing a user to perceive a hit vibration input area.
